(19) United States
(12) Patent Application Publication
(10) Pub. No.: US 2006/0184452 A1
(43) Pub. Date: Aug. 17, 2006

(54) Electronic document management system

(75) Inventors: John P. Barnes, Leesburg, VA (US); Sai Alluru, Ashburn, VA (US); Derek Benner, McLean, VA (US); Naja Buddharaju, Ashburn, VA (US); Taj Chadha, Ashburn, VA (US); Bonnie Kidwell, Bealeton, VA (US); Josh Nan, Fairfax, VA (US); Todd A. Safford, Bethesda, MD (US); Xan Schmickel, Vienna, VA (US); Jack Sponsler, Ashburn, VA (US); Kimberly M. Weaver, Fairfax, VA (US); Bin Zhou Zhou, Oak Hill, VA (US); Peter Davies, Ashburn, VA (US); Lei Zhang, (US)

Correspondence Address: MACCORD MASON PLLC, 300 N. GREENE STREET, SUITE 1600, P. O. BOX 2974, GREENSBORO, NC, 27402, US

(73) Assignee: MacCord Mason PLLC,

(21) Appl. No.: 10/685,302

(22) Filed: Oct. 14, 2003

(51) Int. Cl. G06Q 99/00; H04L 9/00; H04K 1/00

(52) U.S. Cl. 705/50

(57) ABSTRACT

An electronic document management system. The system includes a document entry module; a document management module; and a real time digital certificate generator for effecting electronic signatures. In the preferred embodiment, the system further includes a document repository module for storing documents and for accessing documents.

### BACKGROUND OF THE INVENTION

(1) Field of the Invention

The present invention relates generally to an electronic document management system, and more particularly, to an electronic document management system including a real-time digital identity/certificate generator for effecting electronic signatures specifically adapted for effecting electronic mortgage closings.

(2) Description of the Prior Art

### I. The Mortgage Industry

Most mortgage industry processes are essentially reviewing and collecting the appropriate documents necessary to determine whether or not to perform the next task in the sequence of originating, selling or servicing a loan. The loan officer or loan processor orders, collects and reviews documents from the credit bureau, property appraiser, flood certification company, tax certification company, surveyor, title insurance company, closing agent, hazard insurance company, borrower, borrower's banking institutions, borrower's employers, real estate agent, and others as needed. Some of the documents ordered from the borrower may be created by the processor or loan officer and sent to the borrower for execution. The loan underwriter reviews all of these documents to determine whether the loans meet the company's requirements for adequate credit, capital and collateral. The loan closer, after reviewing the growing collection of documents, adds more documents to the loan file—namely, those documents the borrower is required to execute to obtain the actual funds for the loan. The closing agent reviews the documents with the borrowers, guides the borrower through signing them, executes and notarizes them as appropriate, and returns them to the mortgage company. There, a post closer reviews all of the documents for compliance to industry and investor standards, a necessary precondition to selling or insuring the loan. The document review may turn up documents that were not properly completed, and then the cycle begins again, with the closing agent or lender having to return to the borrower and have them execute the document(s) correctly. After the loan documents have passed the quality control and compliance audit, they may be copied and sent to an investor for review. The investor will review the documents in detail as part of deciding whether or not to purchase the loan. If the investor decides to purchase the loan and the mortgage company has also decided to sell the servicing rights to the loan (the right to receive and disburse the monthly mortgage payment from the borrower), the servicer also performs a quality control review check. Additionally, during this time, the mortgage company's post closer is tasked with following up on certain documents that were not returned by the closing agent with the original closing package. These are usually the documents that must be recorded, such as the security instrument. If the investor or servicer decides to sell the loan or loan servicing rights after purchasing them, the cycle of forwarding documents and loan information to another party for review begins again. When the borrower pays off the loan, certain documents must be located and invalidated (such as the note and security instrument) and returned to the borrower. Usually additional documents must be created when a loan is paid off and recorded; the recorded document must eventually end up in the hands of the appropriate parties, which may be the borrower or mortgage company.

Therefore, the paper trail continues to grow throughout the life cycle of the loan; there is an initial spurt of paper generation which then is followed by a period of reviewing that paper; followed by another spurt of document generation which is followed by another review period; then the documents are carefully archived until the last documents are generated, which are those necessary to release the lien. During all most of these processes, the documents are generally physically transferred from one party to the next, multiplying the originals into several file copies exponentially.

To complicate matters, because the American mortgage process can involve seven participants or more, with all of the data and documents coming from this combination of participants, the data from the documents is inevitably re-keyed into different systems, thereby increasing the potential for error.

### II. The Mortgage Processes

The current American processing process consists of ordering the required documentation needed to verify the borrower's claims about the borrower as well as the property that is being used as collateral for the loan. These documents are generally ordered from multiple providers, and the loan processor or loan officer must track the ordering, receipt, and review of these documents. The method of ordering documents varies by the document provider; therefore the loan processor may call the closing agent to schedule the closing, fax the appraisal request to the appraiser, order the credit report or flood certificate online, and so on. The timing of gathering all of these documents is critical to maintaining the borrower's interest in obtaining the loan from the chosen mortgage company, as well as ensuring the loan closing occurs on schedule.

Although many service providers are now returning their documents electronically, the problem still remains for the lender on how to manage these documents by associating and attaching them to the correct loan file. Some service providers are also returning a separate data file with their documents, allowing the lender to easily update their system of record (commonly called a Loan Origination System) with the information from the document.

Even with a moderate or high amount of electronically enabling the processing steps, the closing process becomes another mountain of paper. Documents may be sent to closing agents in paper form or electronically, but the end result is a stack of documents for the closing agent and borrower to wade through in the traditional half-hour or hour generally allotted for loan closings.

The current American mortgage closing process consists of two main models: traditional closings and witness closings. Traditional closings are used for purchases and some refinances. The borrowers (and sellers, if applicable) come to the closing agent's office, or a mutually agreed-upon location. The closing agent reviews the documents with the parties, explaining the documents. As each document is reviewed, the closing agent obtains the wet-ink signatures of the applicable parties on the document, and notarizes those documents requiring notarization.

The second model of mortgage closing, also known as the witness or signature closing, is gaining momentum with the refinance market. In this model, the lender still sends the documents to the closing agent/signing agent; or may even send the documents to the borrower directly. If the documents are sent to a closing agent, the closing agent schedules an appointment with the borrower, generally at the borrower's home or office. If the documents are sent to the borrower, the borrower is instructed to find a notary public in their area and arrange their own appointment with the notary public. The actual signing of the documents takes place with just the borrower(s) and the notary, and the notary offers little or no document explanations, depending on the laws for that state. The signing agent/notary's purpose in this model is purely to witness the signing of the documents and notarize them as needed. After the documents have been signed, either the notary returns them to the closing agent (who then forwards them to the lender), or the borrower returns them to the lender.

In both of these models, the lender has performed a significant identification check on the borrowers as part of underwriting their loan application. The closing agent has performed an identification check on the borrowers and sellers as part of fulfilling the conditions of the title binder, which the title insurer requires in order to issue the title insurance policy. At the closing itself, the notary (who may also be the closing agent/signing agent, or may be an assistant to the closing agent) verifies the borrowers and sellers' identities by photo identification.

In addition, there are liability protections for the parties involved in the closing, that offer possible reimbursement for losses suffered if there is negligence in conducting the closing. The lender may request that the closing agent provide the lender with a specific “Insured Closing Letter” “(ICL)” for each closing. The title insurance company that is providing the title insurance for the loan issues the ICL. The ICL names the title insurance company as liable to the lender if the closing agent does not execute the lender's closing instructions as written, or does not disburse the loan funds properly. Of course, the closing agent may be a branch of the title insurance company, an affiliated business partner, or an independent business partner. The point is that the title insurance company, as part of agreeing to provide title insurance policies for closings that the closing agent performs, has done some level of due diligence on the closing agent company as part of their relationship and as a basis of that due diligence is therefore willing to be liable for the closing agent's behavior under certain conditions.

Additionally, the notary offers a method of recourse for the lender if the notary does not perform the proper verification of identity of the borrowers and sellers. The notary public is a public office and each state has strict laws regarding not only the powers of the notary but also how they must execute their powers—including consequences for notary negligence.

### III. Earlier Attempts at Electronic Closings

Electronic signatures became a legally permissible method of signing with the passage of the federal ESIGN (Electronic Signatures in Global and National Commerce) Act, which became effective Oct. 1, 2000 (15 U.S.C. § 7001 et seq.) Previous to the federal law, a model state law (Uniform Electronic Transactions Act, or “UETA”) had been promulgated by the National Conference of Commissioners on Uniform State Laws in July 1999. This model state law has now been adopted in some form by a majority of the states.

“Electronic signatures” is a blanket term used to convey the many different types of signature by electronic means. Some examples of electronic signature are:
1) A “click” signature wherein a user clicks a “sign” button
2) A “PIN” signature wherein the signer enters a Personal Identification Number (PIN) and clicks a “sign” button
3) A “digital” signature which is created through cryptographic methods of binding information from a digital certificate to the document being signed
4) A “biometric” signature, which uses biological information about the signer (retina scan, fingerprint) as part of the signature

Electronic signatures have been used in pilot programs for mortgage loan processes (see a synopsis of industry efforts in “Closing In on a Paperless Mortgage” by Patrick Barta, the Wall Street Journal, Jun. 16, 2003). Electronic signatures may be used for signing upfront disclosures as well as the mortgage loan closing documents (see “Quicken Rolls Out Silanis e-Signatures for Consumer Mortgage Loans” by Scott Kersnar, National Mortgage News, Oct. 14, 2002). Some of the electronic signatures considered in these pilots have been digital signatures as well as click or PIN signatures.

An example of a current electronic closing process requires borrowers, sellers, and signing agents (notaries public) to go to a certificate authority—a company that issues digital certificates—to apply for and retrieve a digital certificate. An electronic closing software system typically contains a link to a certificate authority's website where the person desiring a digital certificate must enter some personal information. The person must also specify a password that the certificate authority will use to authenticate the person when he or she retrieves the certificate. Each party must purchase a digital certificate using a credit card number or payment voucher. The process of applying for and receiving a certificate generally takes at least 1-2 weeks, because the certificate authority performs an identity check on the person. This is also called “identification and authentication” or “I & A.” It is usually done by verifying information that the person has provided against a private information database such as a credit reporting bureau or address bureau. After the certificate has been issued, the certificate authority sends a notice to the person, usually through regular post office mail, that the certificate is ready for electronic “pickup.” The person must log into the certificate authority's website, enter her password, retrieve the digital certificate, and then save it to the certificate store on her Internet browser. Finally, the person must then save (export) the digital certificate to some form of electronic media and bring it with them to the closing appointment.

At the closing, which generally may only occur in a browser or offline session opened by the signing agent, the signing agent must import the borrowers and sellers' digital certificates from the electronic media into the certificate store contained in the internet browser on her computer. After the certificates have been put into the signing agent's certificate store, the signing agent must then associate (register) each of the certificates to a correct user identification number. This step is a security measure to assure that the user is not attempting to sign with someone else's digital certificate, during the signing process. After the certificates have been manually registered to their users' respective user identification number, the signing agent goes to a screen that displays all of the documents to be signed electronically. The signing agent can determine the order in which the documents display. The parties view each document one by one, executing each document before they can go on to the next one. However, during the act of signing a document, the user must still select her digital certificate from the certificate store of the signing agent's computer to apply it to the document. To do so, the user displays all of the certificates loaded onto the signing agent's computer, highlights their certificate in the list, and clicks a button labeled “Sign.” After all of the documents have been signed, the signing agent must manually delete the certificates from the certificate store on their computer.

### IV. Problems with the Earlier Electronic Closing Process

The problems with the current process can be generally divided into usability, security and financial items, as listed below.

Certificate Issuance Process

Financial
Because the standard validity period of digital certificates is for one year, the cost is greater.
Having the certificate authority perform the “identity verification” of the borrowers and sellers greatly increases the price of the certificates for these users.
The actual process of paying for the certificates is costly to administer.

Usability
Digital certificates are a new technology to most people; and therefore many people are cautious to antagonistic about the use of them.
Users must go to a certificate authority to obtain their certificate.
The certificate authority websites may be generic, meaning users may have to print out instructions on how to apply for the certificate, and then follow them carefully.
The certificate application asks questions about private information that is necessary to validate the person's identity but the user could view the questions as invasive or excessive.
The certificate application process, from time of application until the certificate is issued, takes too long in light of the industry push to originate and close loans on the same day.
From the perspective of the closing agent and lender, it is difficult for them to manage and ensure that the borrowers and sellers have performed the certificate application process in a timely manner prior to the closing date.
If the borrowers or sellers do not apply for their certificates in time, forget to bring their certificate with them to closing, etc., the closing must be rescheduled.

Security
The lender cannot control what name the borrowers (and sellers) use for their digital certificate. This allows “document undersigning” whereby the borrower may apply for their certificate in the name of Kim Doe when the printed name on their loan documents is shown as Kimberly M. Doe. The borrower must sign the documents either as their name is typed on the document, or “over sign” the document.
Many people are not comfortable with obtaining and using a digital certificate, especially when it is largely a “do-it-yourself” process.
No one is verifying in the process that the certificate Jane Borrower brings to closing is really Jane Borrower's certificate.

Signing Process

Usability
Making the signing agent user manually register each certificate to the appropriate user creates an opportunity for error.
Requiring the user to select her certificate from a dropdown list creates an opportunity for error.
If the borrower or seller has not logged into the system with her own user ID/password prior to closing, she will not have acknowledged an explanation of mandated consumer protections.

Security
The effect of viewing all of the certificates loaded on the computer being used for the closing could be disconcerting for borrowers and sellers.
The signing agent user, who is responsible for conducting the electronic closing, must manually remove all of the borrower and seller certificates from the computer used to conduct the closing.
Each certificate currently obtained is valid for one year, which potentially increases the opportunity for fraud if the certificate is not removed from the computer.

### V. Electronic Document Storage

Many lenders have begun imaging the loan documents in an effort to reduce the stacks of manila file folders. This is sometimes done through the loan process, but generally most lenders who image documents do so at the end of the loan origination process, after the loan has closed. However, most electronic document storage systems are basically archive systems and generally do not have any of the secondary market processes included in their workflow.

Thus, there remains a need for a new and improved electronic document management system including a real-time digital certificate generator for effecting electronic signatures that overcomes many of the problems with the prior art electronic closing process while, at the same time, provides a document repository module including means for storing documents and means for accessing documents.

### SUMMARY OF THE INVENTION

The present invention is directed to an electronic document management system. The system includes a document entry module; a document management module; and a real time digital certificate generator for effecting electronic signatures. In the preferred embodiment, the real time digital certificate generator includes: (i) means for entering data for certificate recipient including an entrusted identification and authentication (I&A); (ii) means for generating a key pair; (iii) means for transmitting data to a certificate authority; and (iv) means for receiving the digital certificate from the certificate of authority. Also, in the preferred embodiment, the system further includes a document repository module for storing documents and for accessing documents.

In the preferred embodiment, the document entry module includes means for uploading documents and means for naming each document. The means for uploading documents includes means for specifying documents to be uploaded. Also, the means for uploading documents includes means for uploading documents singly. The means for uploading documents includes means for uploading document packages.

The means for uploading documents includes means for uploading documents via a business-to-business (B2B) integration with document source. The means for uploading documents may include means for uploading documents through a web browser.

The means for uploading documents may include means for specifying the structure of the document package. The means for selecting the structure of the document package includes means for defining the structure of the document package.

In the preferred embodiment, the means for specifying the structure of the document package includes means for cataloguing and storing structures of document packages. The means for cataloguing and storing structures of document packages may include means for describing a business purpose of a document. The means for cataloguing and storing structures of document packages includes means for parsing the contents of document packages into individual documents.

In the preferred embodiment, the documents are imported electronically. However, the documents may be scanned into an electronic format prior to being imported. In the preferred embodiment, the document format is selected from the group consisting of PDF, XHTML, PCL, JPEG, GIF, TIFF, PS and XML and combinations thereof. The documents may also be generated externally.

The means for naming each document may further include means for associating related entries of documents. Also, the means for associating related entries of documents may includes means for associating related entries of documents in a hierarchal manner. The means for naming may further include means for naming each document.

In the preferred embodiment, the document entry module further includes means for setting privileges. The document management module may include means for displaying documents and means for attaching an electronic signature to a document. In the preferred embodiment, the means for attaching an electronic signature to a document includes means for attaching a system-generated tamper seal.

In the preferred embodiment, the means for attaching an electronic signature to a document includes means for permitting system users to attach a click signature to a document. The means for attaching an electronic signature to a document may include means for permitting system users to attach a biometric signature to a document.

The means for displaying may include a browser. In the preferred embodiment, the browser is an Internet browser. However, the means for displaying may be a Personal Digital Assistant (PDA) or a kiosk, wherein the kiosk is located at the closing agent.

In the preferred embodiment, the means for attaching electronic signature is a digital certificate to effect a digital signature. The means for attaching electronic signature may be a pin signature to effect signature.

The document management module may further include an order module. The order module may include a list of available service providers and means of selecting one or more services from the service providers. In one embodiment, the list of available service providers is a product catalog. The order module may further include filtering means. In the preferred embodiment, the filtering means is a preferences filter. The filtering means may also be a locations filter. The order module may further include means for associating one or more documents with a selected entry.

In the preferred embodiment, the document management module further includes means for printing documents. The document management module may further include means for downloading electronic copies of documents. The document management module may further include means for deleting selected documents. Also, the document management module may further include means for displaying document histories. The document management module may further including means for changing document privileges.

In the preferred embodiment, the real time certificate generator further including means for automatically associating the digital certificate with the certificate recipient system user ID. The real time certificate generator may further including means for automatically removing the certificate. The means for automatically removing the certificate may removes the certificate from means for data entry.

The real time certificate generator may further include means for providing secondary verification. In the preferred embodiment, the means for providing secondary verification is a system user ID.

In the preferred embodiment, the means for initiating the generation of a key pair for the digital certificate may further include means for generating the initiation of a key pair for a browser-based digital certificate. Also, the means for initiating the generation of a key pair for the digital certificate may further include means for generating the initiation of a key pair for a roaming digital certificate. The means for initiating the generation of a key pair for the digital certificate may further include means for generating the initiation of a key pair for a hardware-based digital certificate.

In the preferred embodiment, the means for receiving the digital certificate from the certificate authority further includes means for automatically installing the certificate on a computer's browser. The real time certificate generator may further include means for managing the life cycle of the certificate from within the document management system. The means for managing the life cycle of the certificate from within the document management system may include means for performing processes necessary to renew the digital certificate. In the preferred embodiment, the means for managing the life cycle of the certificate from within the document management system includes means for revoking the digital certificate. Also, the means for managing the life cycle of the certificate from within the document management system may include means for performing processes necessary for certificate recipient customer support.

In the preferred embodiment, the means for accessing documents includes means for sorting documents. Also, the means for accessing documents may include means for versioning documents.

The means for accessing documents may include means for performing validations on documents. In addition, it may further include means for filtering documents by user-defined criteria. The means for filtering documents by user defined criteria includes means for defining filters. The means for filtering documents may include pre-selected criteria. The pre-selected criteria may include grouped documents. Also, the means for filtering documents by user defined criteria may further include means for grouping filtered documents.

In the preferred embodiment, the document repository module further includes a transactions module. The transaction module may further include means for batch transferring documents.

Accordingly, one aspect of the present invention is to provide an electronic document management system, the system comprising: a document entry module; a document management module; and a real time digital certificate generator for effecting electronic signatures.

Another aspect of the present invention is to provide a real time digital certificate generator for effecting electronic signatures for an electronic document management system, the apparatus comprising: means for entering data for certificate recipient including an entrusted identification and authentication (I&A); means for initiating the generation of a key pair for the digital certificate; means for transmitting data to a certificate authority; and means for receiving the digital certificate from the certificate authority.

Still another aspect of the present invention is to provide an electronic document management system, the system comprising: a document entry module; a document management module; a real time digital certificate generator for effecting electronic signatures, the real time digital certificate generator including: (i) means for entering data for certificate recipient including an entrusted identification and authentication (I&A); (ii) means for generating a key pair; (iii) means for transmitting data to a certificate authority; and (iv) means for receiving the digital certificate from the certificate of authority; and a document repository module for storing documents and for accessing documents.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic diagram illustrating an electronic document management system constructed according to the present invention;

FIG. 2 is a schematic diagram of a document repository module including means for storing documents and means for accessing documents;

FIG. 3 is a schematic diagram of a document entry module for an electronic document management system;

FIG. 4 is a schematic diagram of a document management module for an electronic document management system;

FIG. 5 is a schematic diagram of a real-time digital certificate generator for effecting electronic signature for an electronic document management system;

FIG. 6 is a screen shot showing a user interface for the document entry module for an electronic document management system constructed according to the present invention;

FIG. 7 is a screen shot showing a user interface for a means for specifying the structure of a document package for an electronic document management system constructed according to the present invention;

FIG. 8 is a screen shot showing a user interface for a means for cataloguing and storing structures of document packages and a means for parsing the contents of document packages into individual documents for an electronic document management system constructed according to the present invention;

FIG. 9 is a screen shot showing a user interface for a document management module for an electronic document management system constructed according to the present invention;

FIG. 10 is a screen shot showing a user interface for a real-time certificate generator for an electronic document management system constructed according to the present invention;

FIG. 11 is a screen shot showing a user interface for performing digital certificate processes for an electronic document management system constructed according to the present invention;

FIG. 12 is a screen shot showing a user interface for a means for managing the life cycle of certificates for an electronic document management system constructed according to the present invention;

FIG. 13 is a screen shot showing a user interface for a means for receiving digital certificates from a certificate authority for an electronic document management system constructed according to the present invention;

FIG. 14 is a screen shot showing a user interface for a means for removing a digital certificate for an electronic document management system constructed according to the present invention;

FIG. 15 is a screen shot showing a user interface for a means for attaching an electronic signature to a document for an electronic document management system constructed according to the present invention;

FIG. 16 is a screen shot showing a user interface for a means for attaching a digital signature to a document for an electronic document for a document management system constructed according to the present invention;

FIG. 17 is a screen shot showing a user interface for a document repository module for an electronic document management system constructed according to the present invention;

FIG. 18 is a screen shot showing a user interface for a means for accessing documents for an electronic document management system constructed according to the present invention;

FIG. 19 is a screen shot showing a user interface for a means for accessing documents for an electronic document management system constructed according to the present invention;

FIG. 20 is a screen shot showing a user interface for an order module for an electronic document management system constructed according to the present invention;

FIG. 21 is a screen shot showing a user interface for an order module for an electronic document management system constructed according to the present invention;

FIG. 22 is a screen shot showing a user interface for a filtering means for an electronic document management system constructed according to the present invention;

FIG. 23 is a screen shot showing a user interface for a preferences filter for an electronic document management system constructed according to the present invention;

FIG. 24 is a screen shot showing a user interface for a means for accessing documents for an electronic document management system constructed according to the present invention;

FIG. 25 is a screen shot showing a user interface for a means for filtering documents by user-defined criteria for an electronic document management system constructed according to the present invention;

FIG. 26 is a screen shot showing a user interface for a means for grouping documents by user-defined criteria for an electronic document management system constructed according to the present invention;

FIG. 27 is a screen shot showing a user interface for a means for batch transfer of documents for an electronic document management system constructed according to the present invention;

FIG. 28 is a screen shot showing a user interface for a means for setting document privileges for an electronic document management system constructed according to the present invention; and

FIG. 29 is a screen shot showing a user interface for a means for versioning documents for an electronic document management system constructed according to the present invention.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

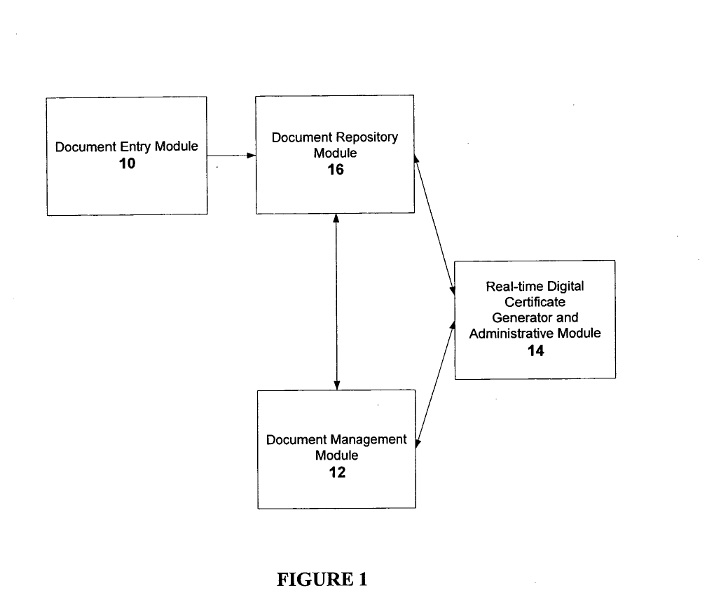

Referring now to the drawings in general and FIG. 1 in particular, it will be understood that the illustrations are for the purpose of describing a preferred embodiment of the invention and are not intended to limit the invention thereto. As best seen in FIG. 1, a schematic diagram illustrating an electronic document management system, generally designated 8, is shown constructed according to the present invention. The electronic document management system 8 includes four major sub-assemblies: a document entry module 10; a document management module 12; a real time digital certificate generator for effecting electronic signatures 14; and a document repository module 16.

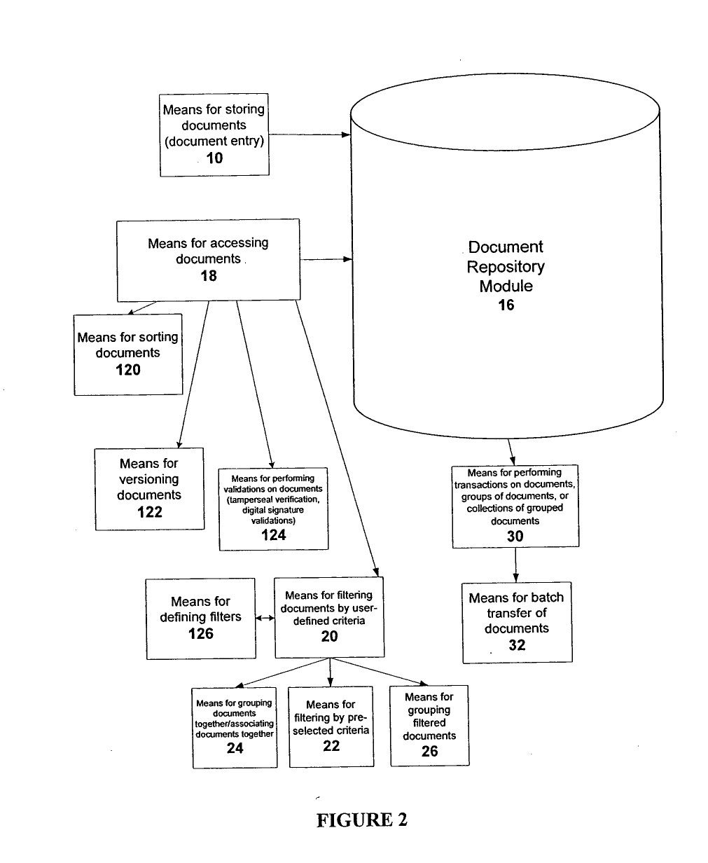

FIG. 2 is a schematic diagram of the document repository module 16 including means for storing documents 17 and means for accessing documents 18. The means for accessing documents 17 includes an HTML user interface to allow users to retrieve a list of documents associated to a loan and a relational data source from which data related to the list of documents is retrieved.

The means for accessing documents 18 of the document repository module includes means for sorting documents 120. The means for sorting documents includes an HTML user interface to sort documents associated to a loan file based on user-specified criteria and a retrieval algorithm utilizing sort capabilities of the underlying relational data source. The means for accessing documents includes means for versioning documents 122 including a relational data store structure that allows different versions of the same document over time. The means for accessing documents includes means for performing validations on documents 124 including W3C XML signature and other related XML specifications, which verify the validity of digital signatures applied to the document and tamper seal. The components are available from iLumin DHS/iCabinet.

The document repository module includes means for filtering documents by user-defined criteria 20 including an HTML user interface that allows users to specify filter criteria by using input fields and Java business objects to pass the user-specified filter criteria, which in turn is used to retrieve the qualified documents from a relational data source. The means for filtering documents by user-defined criteria 20 includes means for defining filters 126 including an HTML user interface for providing input fields for enabling a user to specify filter criteria. The means for filtering documents by user-defined criteria 20 includes means for filtering documents by pre-selected criteria 22 including means for associating documents 24. The means for filtering documents by pre-selected criteria 22 includes an HTML user interface incorporating a system-defined pre-selected or default filter criteria. The means for associating documents 24 includes an HTML user interface for selecting/retrieving a group of documents identified by user-defined identifier and a grouping construct maintained in a relational datastore that provides context to the documents being uploaded including associating the documents with an order and associating orders with loan files. The means for filtering documents by user-defined criteria 20 also includes means for grouping filtered documents 26.

The document repository module 16 also includes a transactions module 30. The transactions module 30 includes an HTML user interface for allowing users to perform system-defined business flows on one or many loans and their related documents. The performed actions are stored into relational data source. The supporting business logic resides in Java objects. The transactions module further includes a means for batch transfer of documents 32. The means for batch transfer of documents 32 includes an HTML user interface for enabling users to transfer ownership of loans and their related documents. The performed actions are stored in a relational data source. The business logic resides in Java objects.

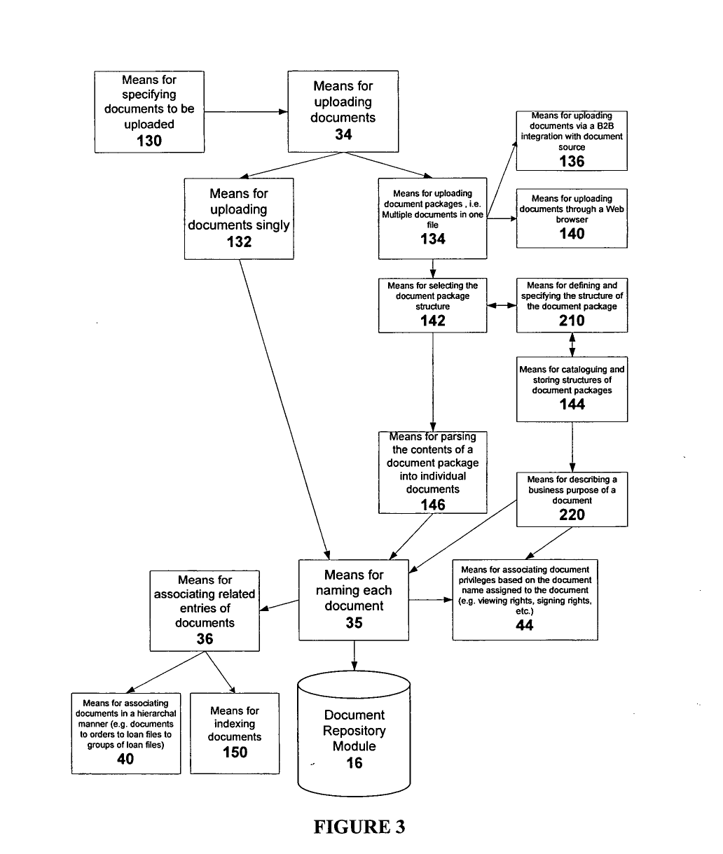

FIG. 3 is a schematic diagram of the document entry module 10 for the electronic document management system 8. The document entry module 10 includes means for uploading documents 34 and means for naming each document 35. The means for uploading documents 34 includes an HTML control for enabling a user to post a selected file as a multi-part form to a server via HTTPS. The means for naming each document 35 includes reference data contained in a database that allows a user or system administrator to characterize the general business purposes of the document.

The means for uploading documents 34 includes means for specifying documents to be uploaded 130, means for uploading documents singly 132, and means for uploading document packages 134. The means for specifying documents to be uploaded 130 includes an HTML control for providing input fields for file selection and file description. The means for uploading documents singly 132 includes an HTML control that enables users to post a selected file as a multi-part form to a server via HTTPS, wherein the selected file is restricted to a GIF, TIF, JPG, XML, PDF, PS, or PCL format and is understood by the user to comprise a single document. The means for uploading document packages 134 includes a mechanism that enables a user to deliver document content wherein the content is understood to be a package containing multiple documents.

The means for uploading documents 34 includes a means for uploading documents via a business-to-business (B2B) integration with document source 136. The means for uploading documents via a business-to-business (B2B) integration with document source 136 includes an XML-based system-to-system interface for enabling the delivery of a payload that is understood to be a package comprised of multiple documents. Encoding, i.e. Base 64, is used for binary payloads.

The means for uploading documents 34 includes a means for uploading documents through a web browser 140. The means for uploading documents through a web browser 140 includes an HTML control that enables users to post a selected file as a multi-part form to a server via HTTPS, wherein the selected file is restricted to a ZIP, JAR, or other archive format, and is understood by the user to comprise multiple documents.

The means for uploading documents 34 includes a means for specifying the structure of the document package 142. The means for specifying the structure of the document package 142 includes an HTML user control for specifying the general classification of the package. This value is one of a defined set of reference data values from the means for defining and specifying the structure of the document package 210.

The means for selecting the structure of the document package 142 includes means for cataloguing and storing structures of document packages 144. The means for cataloguing and storing structures of document packages 144 includes an HTML user interface for collecting reference data describing associations between document identifiers available within the package to the intended business purpose of that document as expressed by reference data from the means for describing a business purpose of a document 220. Other options for the user interface could be utilized including Java Swing and Java Applet.

The means for selecting the structure of the document package 142 includes means for defining and specifying the structure of the document package 210. The means for defining and specifying the structure of the document package 210 includes an HTML user interface for collecting reference data describing a general classification of packages and distinguishing characteristics of such packages and Java classes for managing persistence into relational datastore.

The means for cataloguing and storing structures of document packages 144 includes means for describing a business purpose of a document 220. The means for describing a business purpose of a document 220 includes an HTML user interface for collecting reference data describing the business purpose of a document and Java classes for managing persistence into relational datastore.

The means for cataloguing and storing structures of document packages 144 includes means for parsing the contents of document packages into individual documents 146. The means for parsing the contents of document packages into individual documents 146 includes a processing algorithm implemented in Java that utilizes the package characteristics from the 210 and reference data from 220 to separate a package into the documents it contains.

The documents are imported electronically. The documents may be scanned. The document may be in formats including portable document format (.PDF), printer control language (.PCL), extensible hypertext markup language (.XHTML), joint photographic exports group (.JPEG), graphic interchange format (.GIF), tagged image file format (.TIFF), Post Script (PS) or extensible markup language (XML).

The means for uploading documents 34 of the document entry module also includes means for uploading documents that are externally generated. The means for naming each document 35 of the document entry module includes means for associating related entries of documents 36. The means for associating related entries of documents 36 includes a relational data store structure that allows different versions of the same document over time. The means for associating related entries of documents 36 includes means for indexing documents 150. The means for associating related entries of documents 36 includes means for associating related entries of documents in a hierarchical manner 40. The means for associating related entries of documents in a hierarchal manner 40 includes relational data store maintaining a grouping construct for providing context to the document being uploaded. This includes associating the document with an order, and associating orders with loan files. The means for naming each document 35 includes means for setting privileges 44. The means for setting privileges 44 includes reference data contained in a database that allows system or system administration to specifically relate role-based access control to the documents.

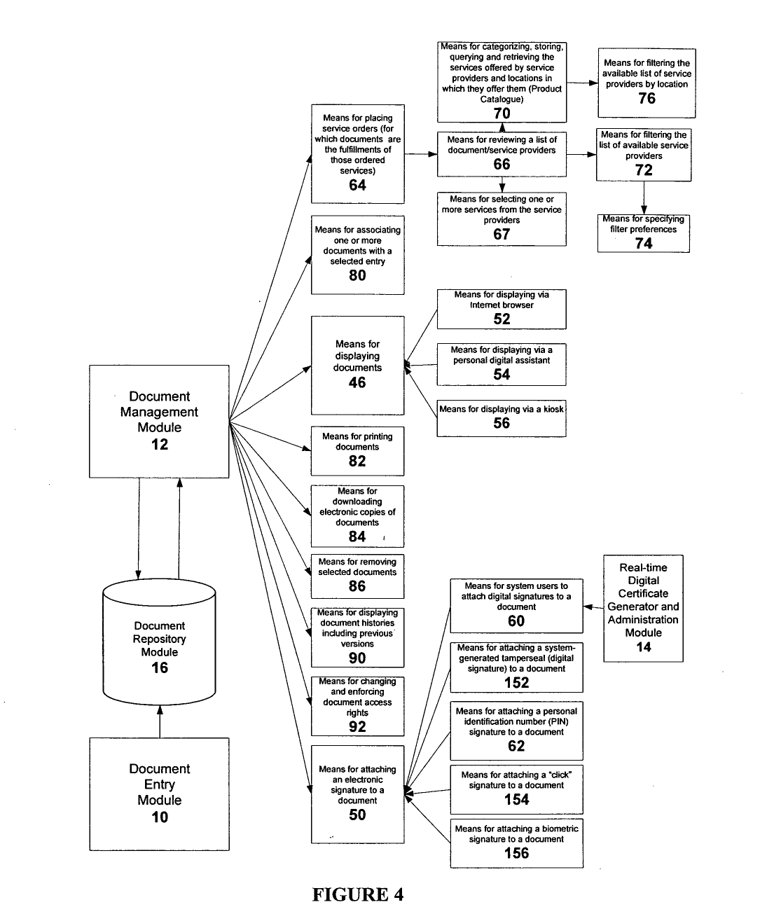

FIG. 4 is a schematic diagram of a document management module 12 for an electronic document management system. The document management module includes means for displaying documents 46 and means for attaching an electronic signature to a document 50. The means for displaying documents 46 includes a document identifier for retrieving content from a relational data source. The document is formatted for an appropriate display device. The relational data source is iLumin DHS/iCabinet and General American Corporation's (GAC) EPN. The means for attaching an electronic signature to a document 50 includes a third-party tool—iLumin—that provides an application program interface (API) for associating a digital signature with a document based on a certificate.

The means for attaching an electronic signature to a document 50 includes means for attaching a system-generated tamper seal 152. The means for attaching a system-generated tamper seal 152 includes a Java business API for generating digital signatures for the complete content of related documents based on a system-wide certificate.

The means for attaching an electronic signature to a document 50 includes means for permitting system users to attach a click signature to a document 156. The means for permitting system users to attach a click signature to a document 156 includes an HTML interface containing an applet that enables a user to use an HTML control for click input.

The means for attaching an electronic signature 50 to a document includes means for permitting system users to attach a biometric signature to a document 156. The means for permitting system users to attach a biometric signature to a document 156 includes commercial-specific HTML plug-ins for capturing biometric data and a Java business API for identifying and validating for generating digital signatures.

The means for displaying documents 46 may include an Internet browser 52, a personal digital assistant (PDA) 54, and/or a kiosk 56. For displaying documents through an Internet browser, the means for displaying documents 46 may rely on features inherent in personal computer browser software or plug-ins available for the personal computer browser. A servlet provided by iLumin may also be utilized. For displaying through a PDA, the means for displaying documents 46 may rely on features inherent in a PDA browser or plug-ins available for the PDA browser. For displaying documents through a kiosk, the means for displaying documents 46 relies on features inherent in the corresponding browser or plug-ins available for the corresponding browser. The kiosk 56 may be located at a closing agent.

The means for attaching an electronic signature 50 is a digital certificate to effect a digital signature 60 or a personal identification number (PIN) signature to effect a signature 62. Where the means for attaching an electronic signature 50 is a digital certificate to effect a digital signature 60, the means may include an HTML containing an applet that displays certificates to generate digital signatures upon activation of an HTML control. Where the means for attaching an electronic signature 50 is a personal identification number signature to effect a signature 62, the means may include an HTML containing an applet that allows user or PIN input and a Java business API that validates the PIN and generates the signature using a system-wide certificate.

The document management module 12 includes an order module 64. The order module 64 includes an HTML user interface, business logic, and storage mechanism that comprise an order management subsystem. A third-party set of components—available from General American Corporation's EPN—may be used for some of the business logic and storage mechanisms, combined with a customer HTML interface and custom business logic.

The order module includes a list of available service providers 66 and means for selecting one or more services from the service providers 67. The list of available service providers 66 includes an HTML user interface that enables a user to select a corporate entity that can provide a selected service. The means for selecting one or more services from the service providers 67 includes an HTML user interface supporting a workflow whereby a user can select multiple services in a sequential manner.

The list of available service providers 66 is a product catalogue 70. The product catalogue includes an HTML user interface, business logic, and storage mechanism, with reference data entity that provides general characterization of products and a mechanism to relate products to corporate entities that allows a system administrator to associate its company/entity with the products and services it offers. The product catalogue also includes on the back end a third-party set of components provided by General American Corporation's EPN for business logic and storage mechanisms, interface and custom business logic.

The order module also includes means for filtering the list of available service providers 72, which is a preferences filter 74. The list of available service providers 72 includes an HTML user interface for providing the capability to restrict or expand the list of available service providers and a retrieval algorithm to construct the list based on supplied criteria. General American Corporation's EPN provides the data and algorithm. The means for filtering the list of available service providers 66 also includes a location filter 76. The location filter 76 includes an HTML user interface for enabling service providers to specify products they can offer in a geographical location and a processing algorithm that utilizes the product catalogue reference data to present or allow a user to select appropriate corporate entities that satisfy conditions specific to a specific context or user-specified criteria. The data is persisted within General American Corporation's EPN.

The order module 64 includes a means for associating one or more documents with a selected entry 80. The means for associating one or more documents with a selected entry 80 includes an HTML user interface that requires documents to be associated to a specific context and the existence of a parent-to-child hierarchy between documents and that specific context implemented within a relational datastore.

The document entry module 10 further includes a means for printing documents 82, means for downloading electronic copies of documents 84, means for deleting selected documents 86, means for displaying document histories 90, and means for changing document privileges 92. The means for printing documents 82 includes HTML and JavaScript to enable a computer's print dialog box and the retrieval of content from a relational datasource given a document identifier. The relational datasource is iLumin DHS/iCabinet and General American Corporation's EPN.

The means for downloading electronic copies of documents 84 allows a user to invoke a mechanism on a remote server, the response to which is the content-associated user-supplied document identifier. A browser interprets the response from the server and provides the option to save the file to a local file system. The content is retrieved from a relational datasource from a relational datasource such as iLumin's DHS/iCabinet and General American Corporation's EPN. A servlet provided by iLumin DHS is utilized.

The means for deleting selected documents 86 includes an HTML interface for selecting documents for deletion. The means for deleting selected documents 86 also includes a document identifier for removing the content and related reference from a relational datasource such as iLumin's DHS/iCabinet and General American Corporation's EPN.

The means for displaying document histories 90 includes an HTML user interface for selecting grouped previous versions of the document for which the history is to be displayed. The means for displaying document histories 90 also includes a document collection identifier for retrieving all related versions and history of the documents from a datasource.

The means for changing document privileges 92 includes a mechanism for enabling an authorized user to assign a predefined access right to a document. The mechanism includes an HTML control for capturing a user's selection of documents using reference data contained in a database that allow the relationship of users to documents. The mechanism includes a document identifier for setting a change document access right property in a datastore.

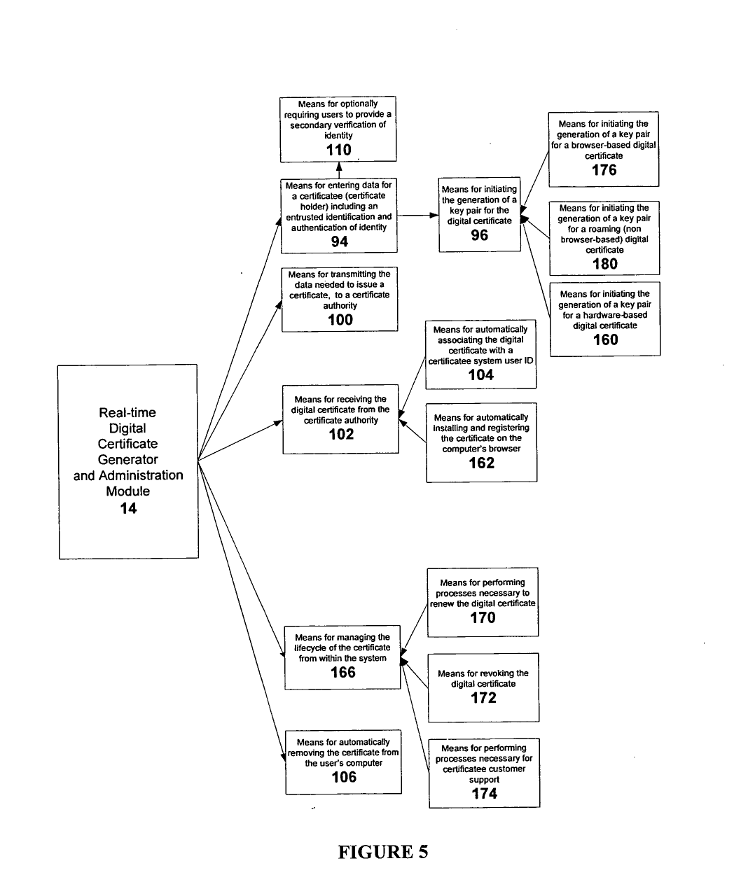

FIG. 5 is a schematic diagram of a real-time digital certificate generator 14 for effecting electronic signatures. The certificate generator 14 includes means for entering data for a certificate recipient including an entrusted identification and authentication (I&A) 94, means for initiating the generation of a key pair 96, means for transmitting data to a certificate authority 100, and means for receiving the digital certificate from the certificate of authority 102.

The means for entering data for a certificate recipient including an entrusted identification and authentication 94 includes an HTML user interface for capturing user identification and authentication information such as but not limited to a drivers' license number. The means for entering data for a certificate recipient including an entrusted identification and authentication 94 also includes Java business objects for verifying and storing the information related to identification and authentication in a datastore.

The means for initiating the generation of a key pair 96 includes cryptography API's for generating a key pair and a datastore for storing the key pair. The means for transmitting data to a certificate authority 100 includes a Java business object for gathering user credential information stored in a datastore and passing such information to VeriSign's public key infrastructure (PKI) component using a defined interface, although the same may be integrated with any managed PKI provider. The means for receiving the digital certificate from the certificate of authority 102 includes a Java business object for receiving the certificate from a VeriSign Managed PKI component, although the same may be integrated with any managed PKI provider.

The certificate generator includes means for automatically associating the digital certificate with a certificate recipient system user identification (ID) 104 and means for automatically removing the certificate 106 wherein the means for automatically removing the certificate removes the certificate from means for data entry 107. The means for automatically associating the digital certificate with a certificate recipient system user identification (ID) 104 includes a Java business object to register/associate a received certificate with an intended user in a datastore. The means for automatically removing the certificate 106 includes an HTML user interface using a VB script-based Crypto API for removing an associated user's certificate from a browser.

The certificate generator also includes means for providing secondary verification 110, which may be a system user ID 111. The means for providing secondary verification 110 includes an HTML user interface for accepting the secondary verification, such as a password, and Java business objects for verifying the password in a datastore. An HTML user interface for managing passwords and Java business objects for managing passwords for a user in a datastore control the system user ID 111.

The means for initiating the generation of a key pair 96 for the digital certificate further includes means for generating the initiation of a key pair for a browser-based digital certificate 176, a roaming digital certificate 180, and/or a hardware-based digital certificate 160. The means for initiating the generation of a key pair for a browser-based digital certificate 176 includes an HTML user interface employing a VB Script-based Microsoft Crypto API for generating a key pair in a default keystore, although any supported cryptography API's may be used.

The means for generating the initiation of a key pair for a roaming digital certificate 180 includes an HTML user interface and a Script-based VeriSign API for generating a key pair in a VeriSign roaming keystore, although any vendor-specific API's that support roaming may be used. The means for generating the initiation of a key pair for a hardware-based digital certificate 160 includes an HTML user interface and script-based API approved by a hardware vendor for generating a key pair in a keystore on the relevant hardware, although any hardware vendor-recommended API's may be used.

The means for receiving the digital certificate from the certificate authority 102 includes means for automatically installing the certificate on a computer's browser 162. The means for automatically installing the certificate on a computer's browser 162 includes an HTML user interface and a VB script-based crypto API for installing a received certificate in a browser. Any supported cryptography API's may be used for installing the received certificate.

The real time digital certificate generator 14 for effecting electronic signatures for an electronic document management system includes means for managing the life cycle of the certificate from within the document management system 166. The means for managing the life cycle of the certificate from within the document management system 166 includes an HTML-based front end for viewing, revoking, and renewing certificates and Java business objects or maintaining the state of certificates in a datastore.

The means for managing the life cycle of the certificate from within the document management system 166 includes means for performing processes necessary to renew the digital certificate 170. The means for performing processes necessary to renew the digital certificate 170 includes an HTML user interface for capturing a user request to renew a certificate and a Java business object for forwarding the request to a VeriSign Managed PKI component and installing a new certificate, although any vendor-specific API's that support these functions may be used.

The means for managing the life cycle of the certificate from within the document management system 166 includes means for revoking the digital certificate 172. The means for revoking the digital certificate 172 includes an HTML user interface for capturing a user request to revoke a certificate and a Java business object for forwarding the request to a VeriSign Managed PKI component for revoking the certificate, although any vendor-specific API's that support these functions may be used.

The means for managing the life cycle of the certificate from within the document management system 166 includes means for performing processes necessary for certificate recipient customer support 174. The means for performing processes necessary for certificate recipient customer support 174 includes an HTML user interface for allowing customer support personnel to review the status of a user's certificate and enable certificate management functions to assist the user in requesting a certificate. The means for performing processes necessary for certificate recipient customer support 174 includes a back end integrated with certificate management functionalities such as renewing and revoking a certificate.

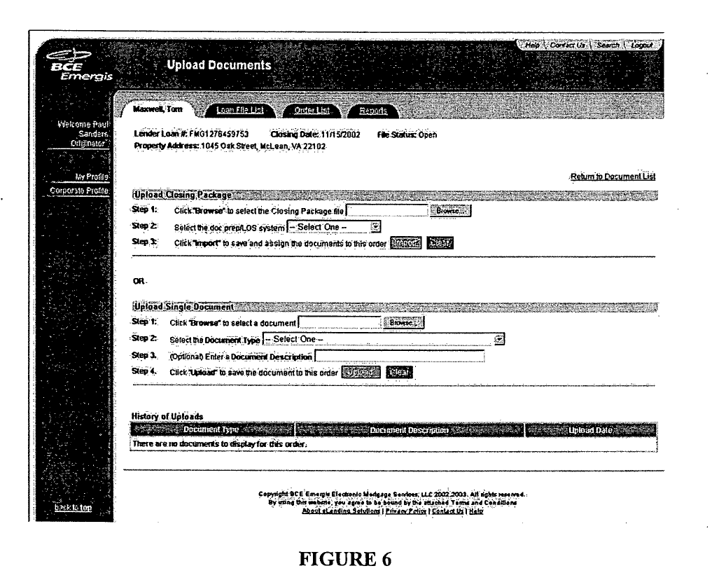

FIG. 6 is a screen shot showing a user interface for the document entry module 10 for an electronic document management system constructed according to the present invention. The document entry module 10 includes a means for uploading documents 34 and a means for naming each document 35. The means for uploading documents 34 includes means for specifying documents to be uploaded 130, means for uploading documents singly 132, and means for uploading document packages 134. The means for naming each document 35 further includes a means for associating related entries of documents 36. The means for associating related entries of documents 36 includes means for associating related entries of documents in a hierarchal manner 40.

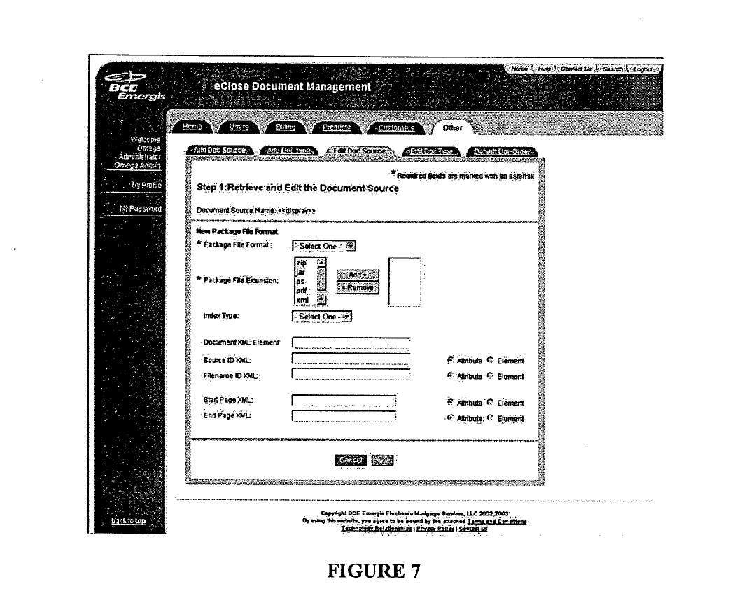

FIG. 7 is a screen shot showing a user interface for a means for specifying the structure of a document package 142 for an electronic document management system constructed according to the present invention.

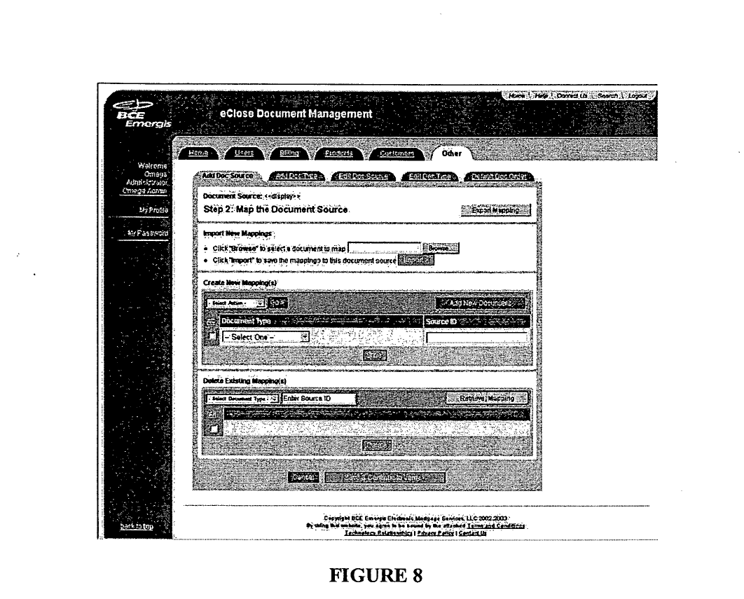

FIG. 8 is a screen shot showing a user interface for a means for cataloguing and storing structures of document packages 144 and a means for parsing the contents of document packages into individual documents 146 for an electronic document management system constructed according to the present invention.

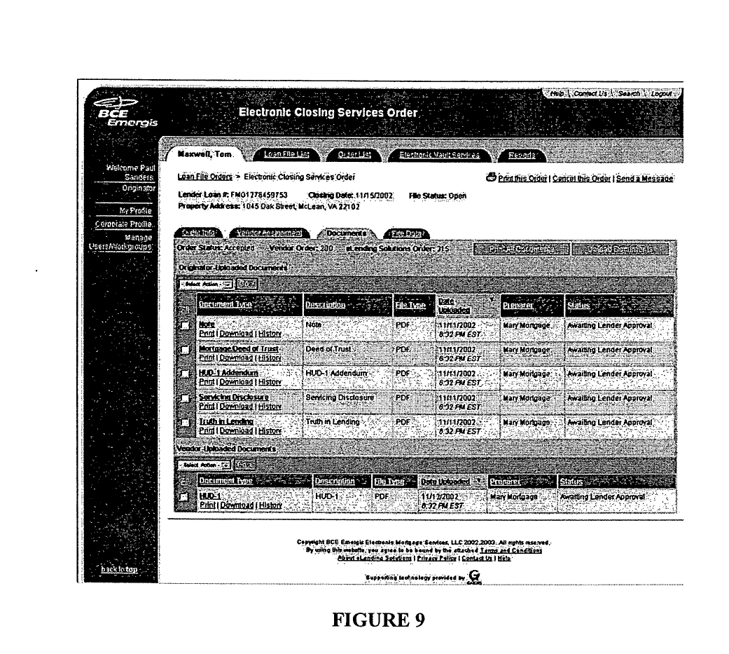

FIG. 9 is a screen shot showing a user interface for a document management module 12 for an electronic document management system constructed according to the present invention.

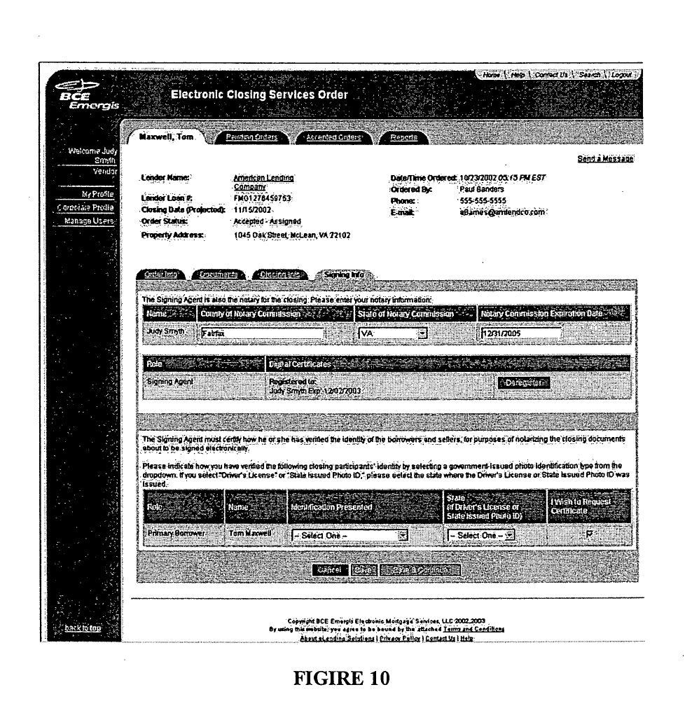

FIG. 10 is a screen shot showing a user interface for a real-time certificate generator 14 for an electronic document management system constructed according to the present invention. The real-time digital certificate generator 14 includes means for entering data for certificate recipient including an entrusted identification and authentication 94. The real-time digital certificate generator 14 includes means for providing secondary identification 110.

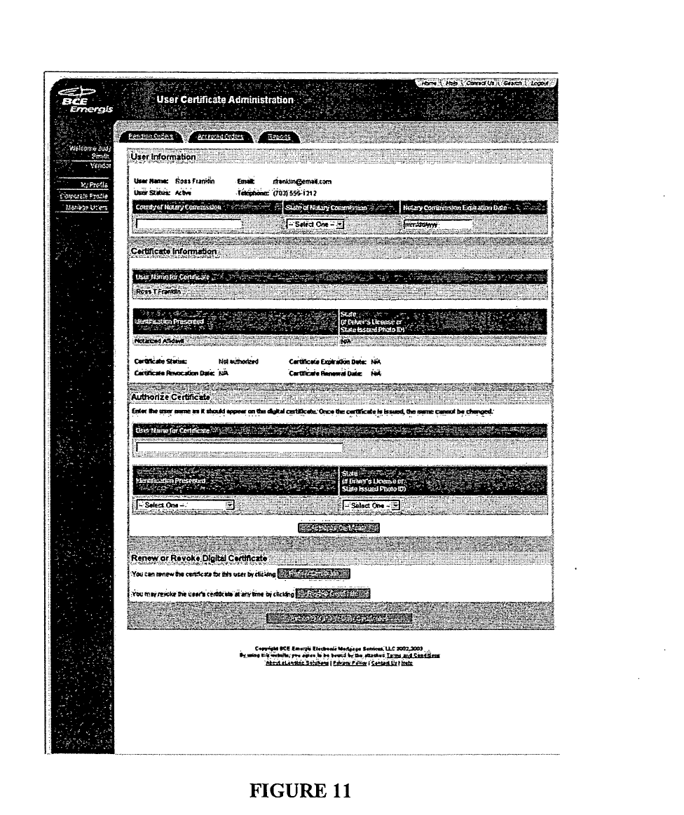

FIG. 11 is a screen shot showing a user interface for performing digital certificate processes for an electronic document management system constructed according to the present invention. The digital certificate processes are performed through means for automatically associating the digital certificate with the certificate recipient system user identification 104, means for automatically installing the certificate on a computer's browser 162, means for performing processes necessary to renew the digital certificate 170, and means for revoking the digital certificate 172.

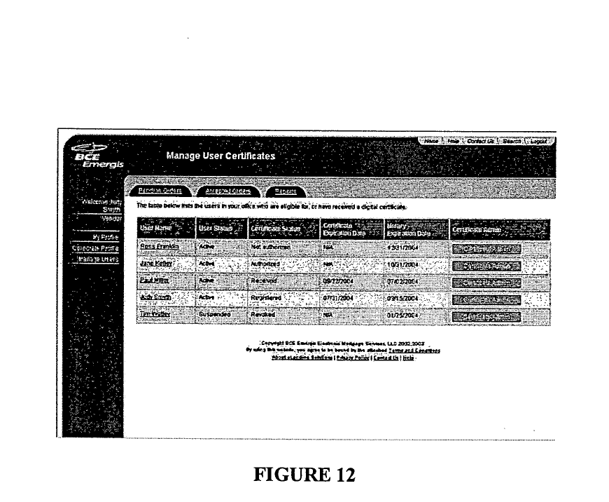

FIG. 12 is a screen shot showing a user interface for a means for managing the life cycle of certificates 166 for an electronic document management system constructed according to the present invention.

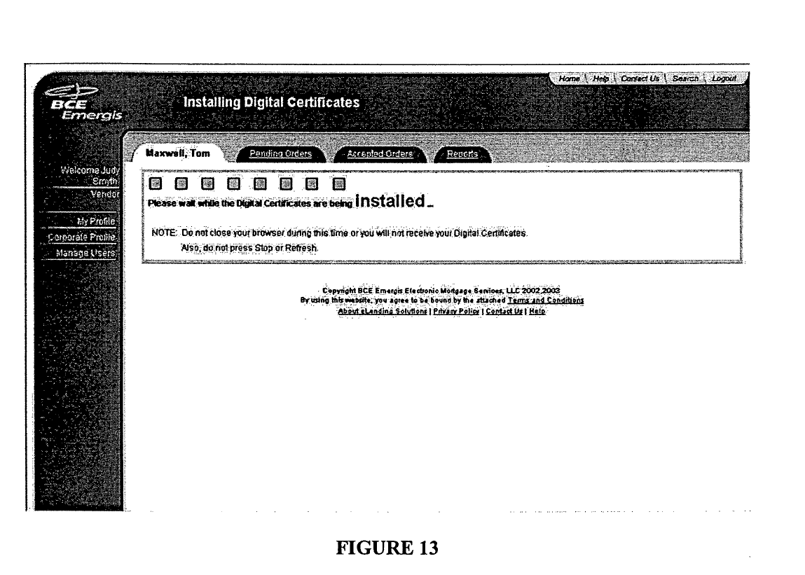

FIG. 13 is a screen shot showing a user interface for a means for receiving digital certificates from a certificate authority 102 for an electronic document management system constructed according to the present invention.

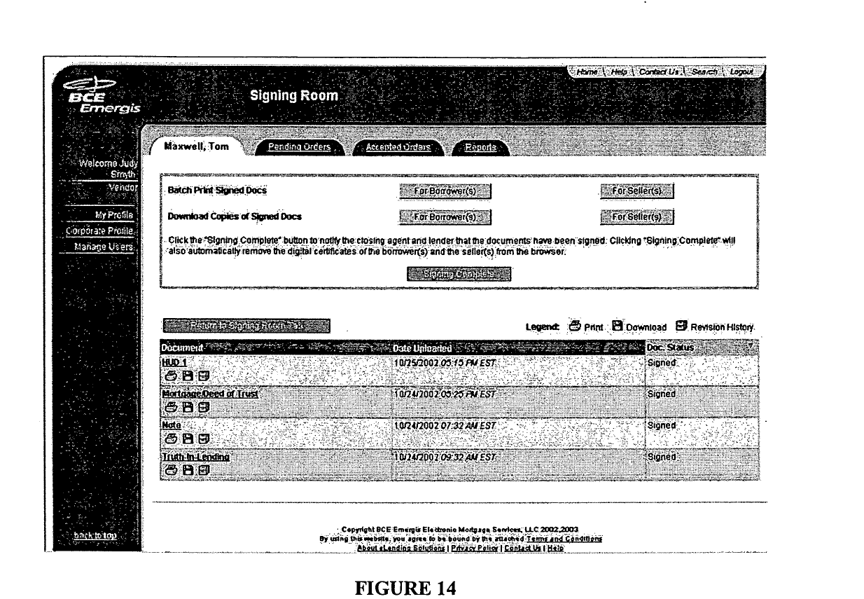

FIG. 14 is a screen shot showing a user interface for a means for removing a digital certificate 106 for an electronic document management system constructed according to the present invention.

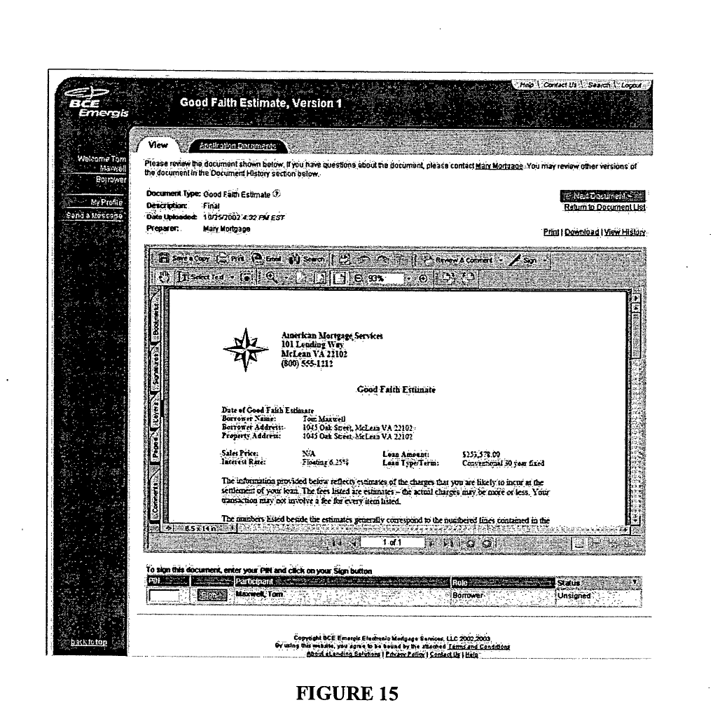

FIG. 15 is a screen shot showing a user interface for a means for attaching an electronic signature to a document 50 for an electronic document management system constructed according to the present invention. The means for attaching an electronic signature to a document is a personal identification number signature.

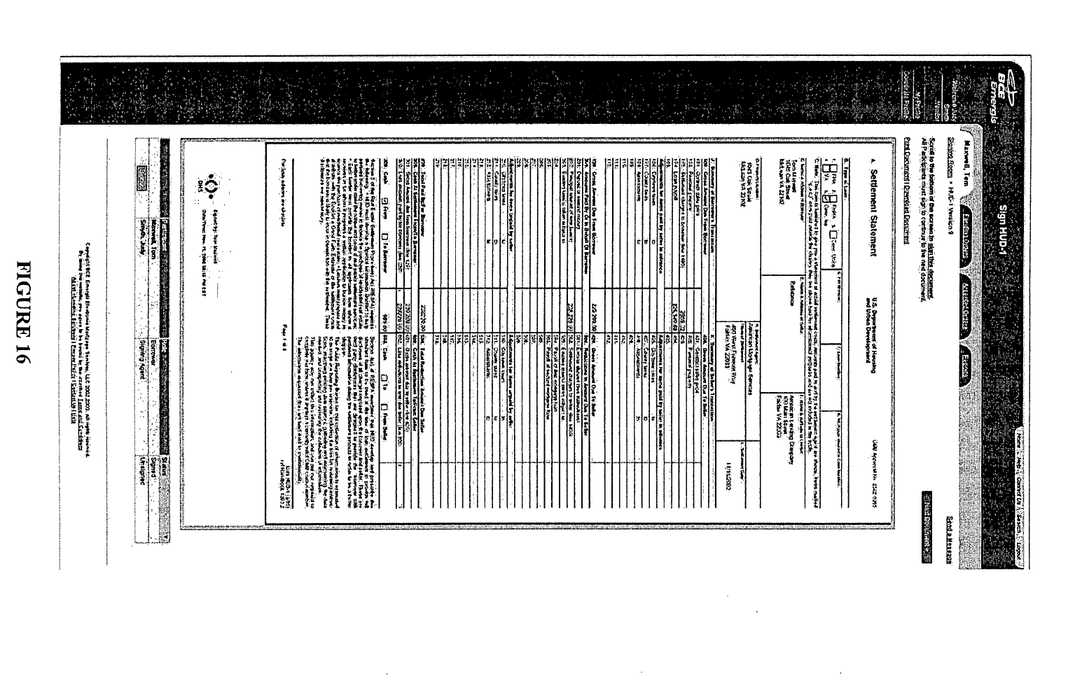

FIG. 16 is a screen shot showing a user interface for a means for attaching a digital signature to a document 60 for an electronic document for a document management system constructed according to the present invention.

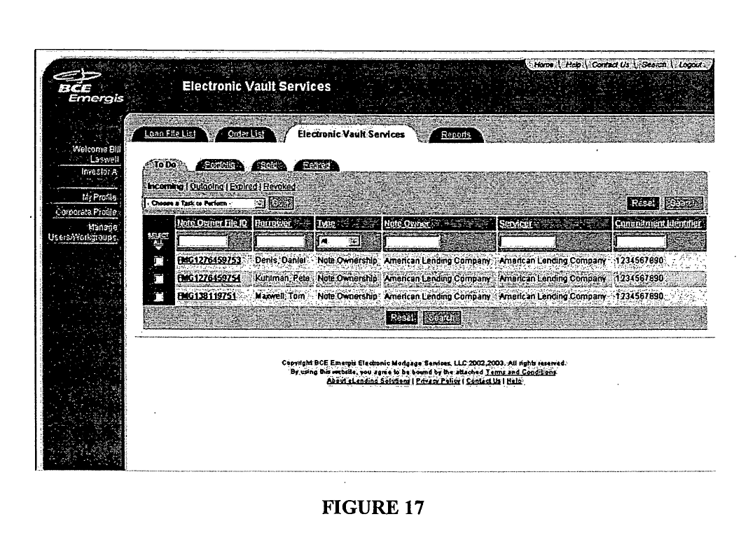

FIG. 17 is a screen shot showing a user interface for a document repository module 16 for an electronic document management system constructed according to the present invention.

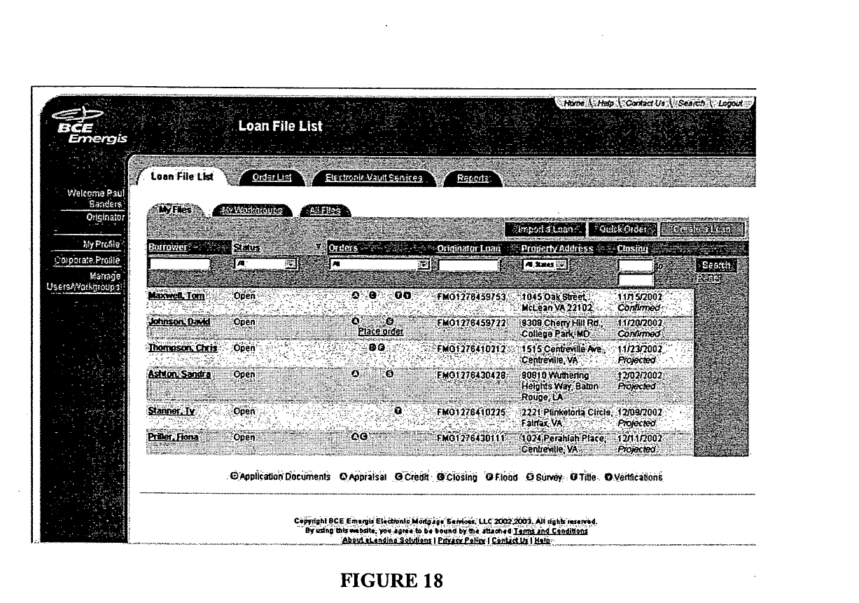

FIG. 18 is a screen shot showing a user interface for a means for accessing documents 18 for an electronic document management system constructed according to the present invention.

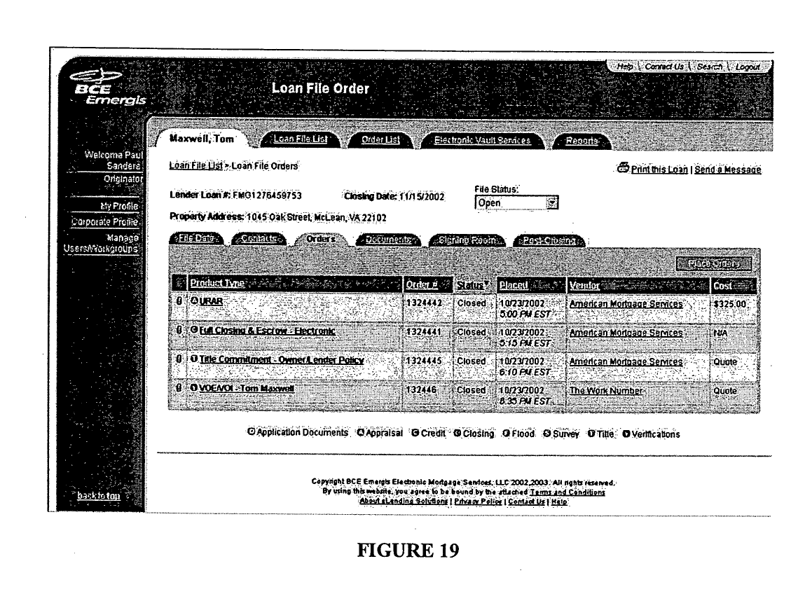

FIG. 19 is a screen shot showing a user interface for a means for accessing documents 18 for an electronic document management system constructed according to the present invention.

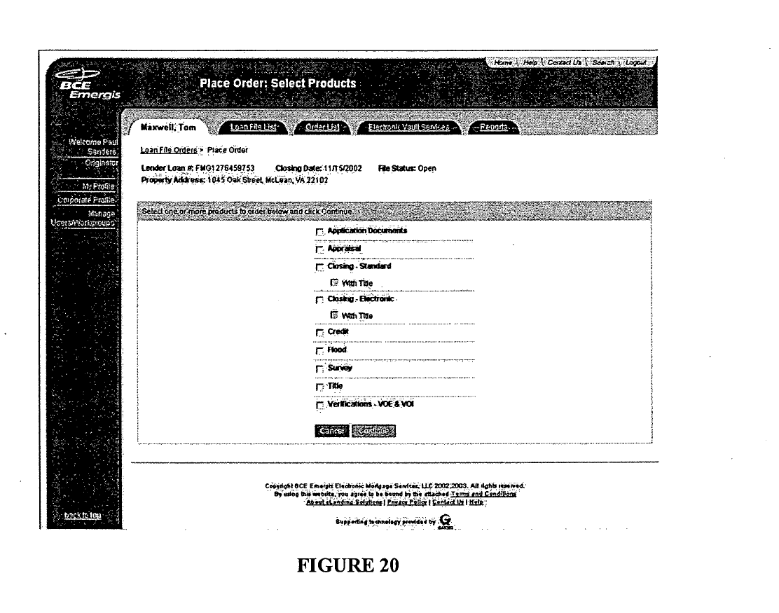

FIG. 20 is a screen shot showing a user interface for an order module 64 for an electronic document management system constructed according to the present invention.

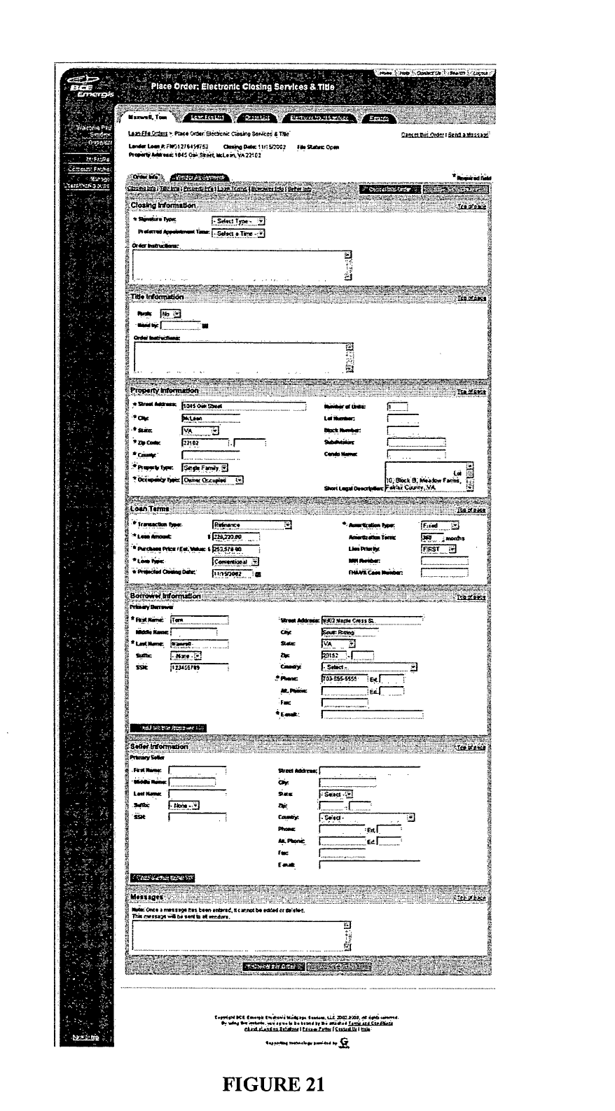

FIG. 21 is a screen shot showing a user interface for an order module 64 for an electronic document management system constructed according to the present invention.

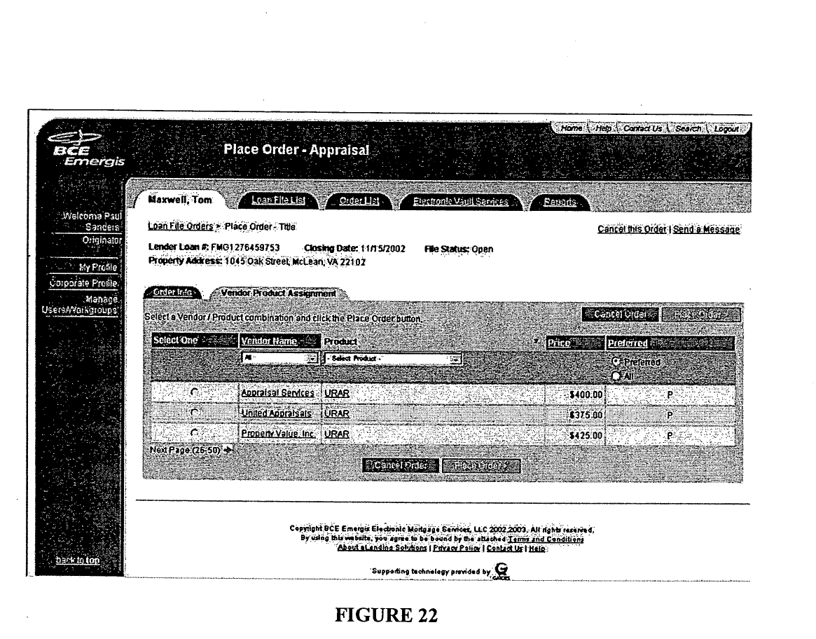

FIG. 22 is a screen shot showing a user interface for a filtering means 72 for an electronic document management system constructed according to the present invention. The order module 63 of the electronic document management system includes a list of available service providers 66 and a means for selecting one or more services from the service providers 67.

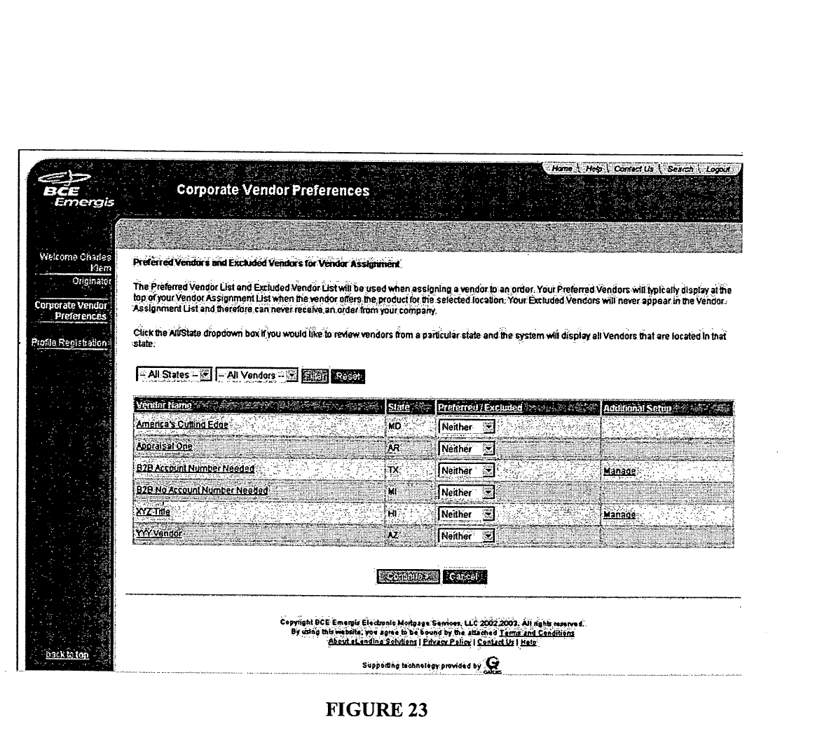

FIG. 23 is a screen shot showing a user interface for a preferences filter 74 for an electronic document management system constructed according to the present invention.

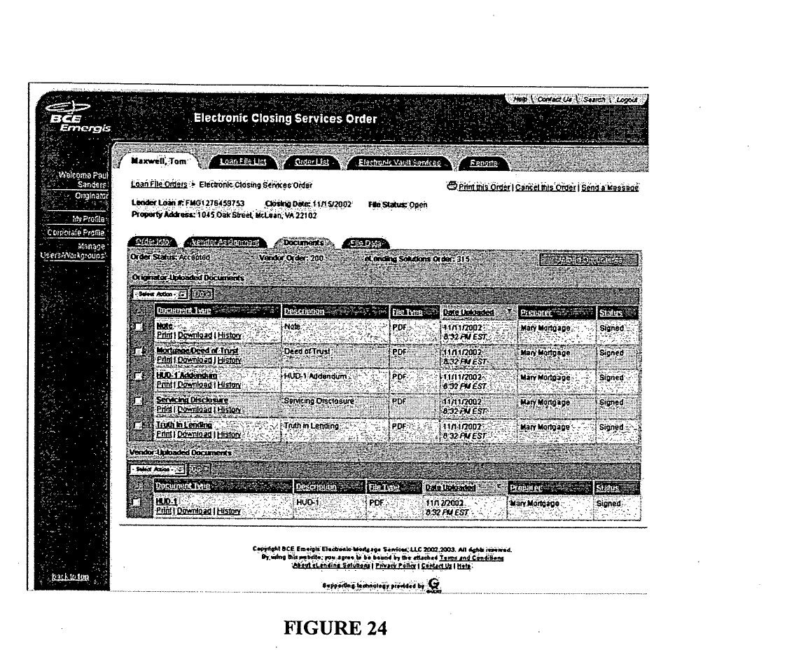

FIG. 24 is a screen shot showing a user interface for a means for accessing documents 18 for an electronic document management system constructed according to the present invention. The means for accessing documents 18 includes means for printing documents 82, means for downloading electronic copies of documents 84, means for deleting selected documents 86, means for displaying document histories 90, and means for changing document privileges 92.

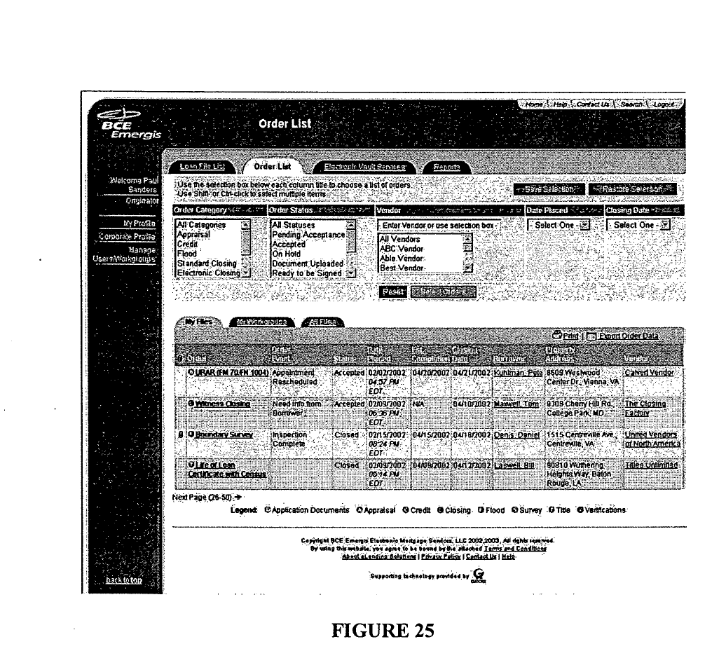

FIG. 25 is a screen shot showing a user interface for a means for filtering documents by user-defined criteria 20 for an electronic document management system constructed according to the present invention. The means for filtering documents 20 includes pre-selected criteria 22 and means for grouping filtered documents 26.

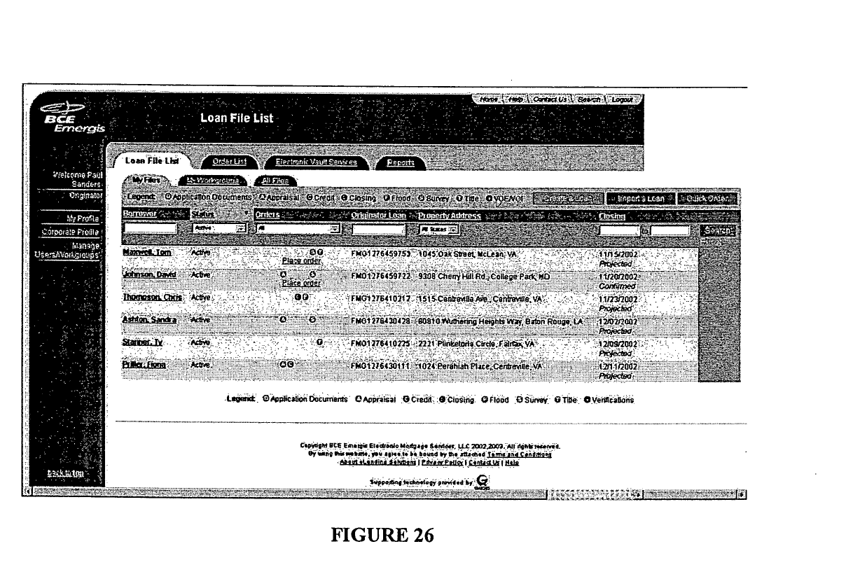

FIG. 26 is a screen shot showing a user interface for a means for grouping documents 24 for an electronic document management system constructed according to the present invention.

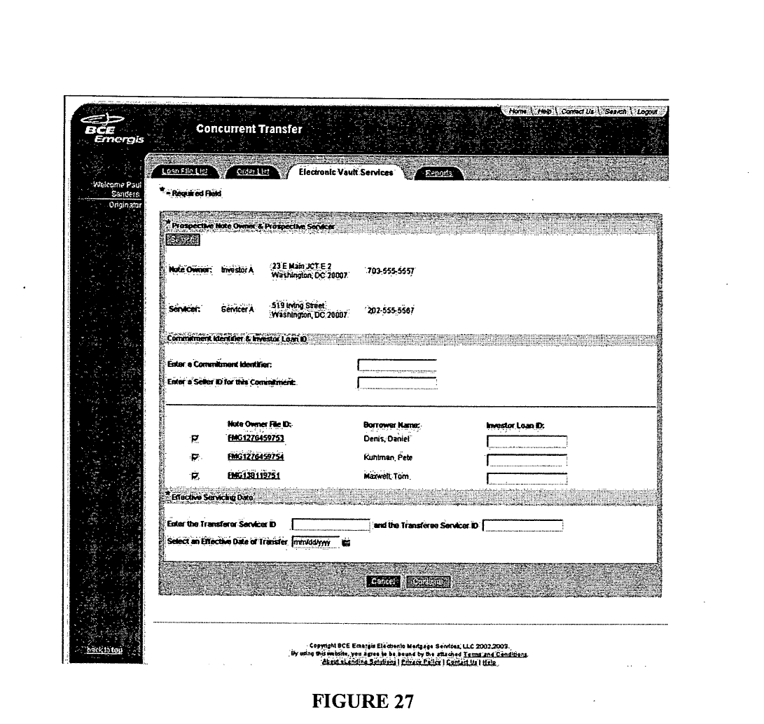

FIG. 27 is a screen shot showing a user interface for a means for batch transfer of documents 32 for an electronic document management system constructed according to the present invention.

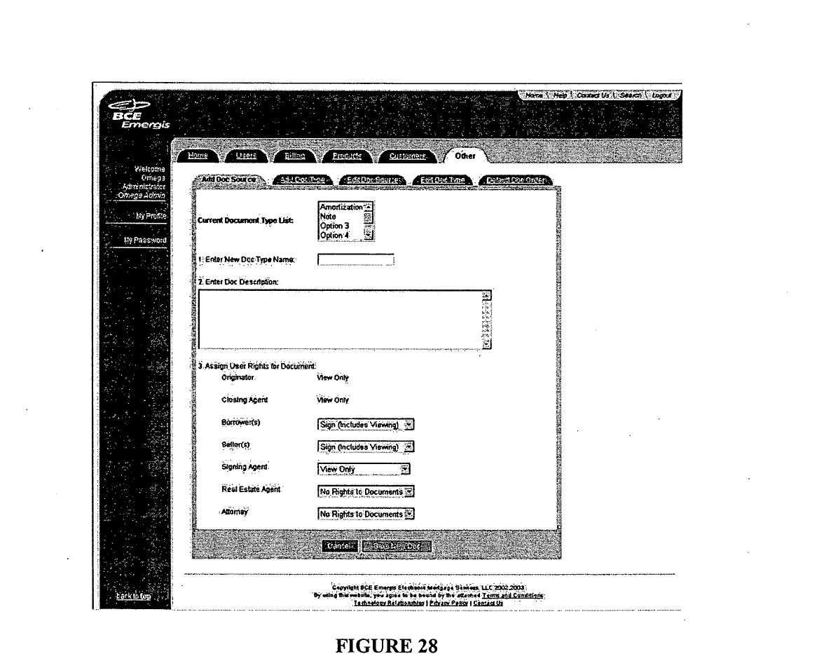

FIG. 28 is a screen shot showing a user interface for a means for setting document privileges 44 for an electronic document management system constructed according to the present invention.

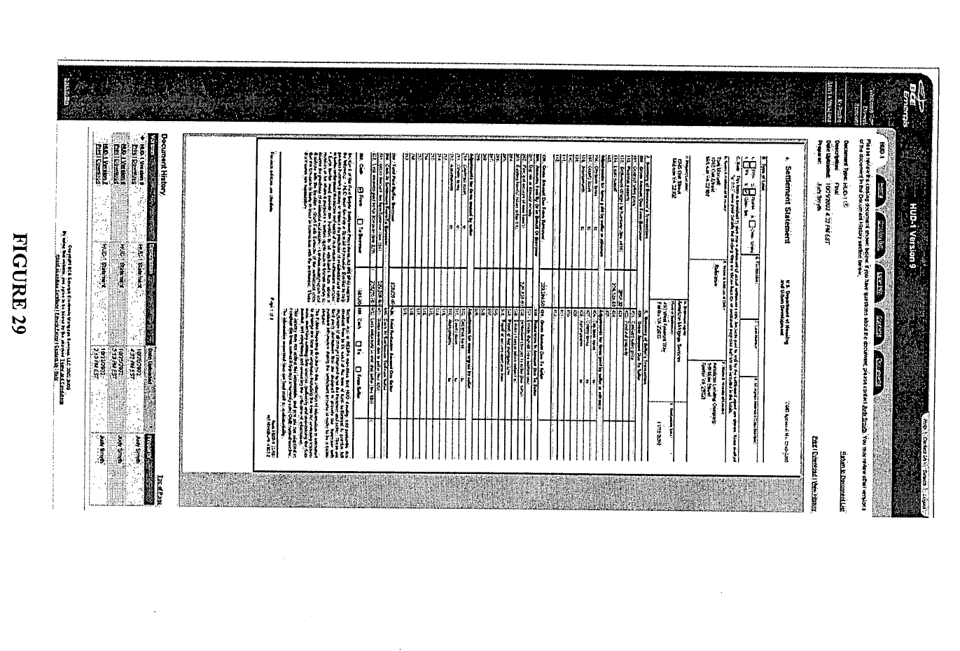

FIG. 29 is a screen shot showing a user interface for a means for versioning documents 128 and means for displaying documents 46 for an electronic document management system constructed according to the present invention.

Certain modifications and improvements will occur to those skilled in the art upon a reading of the foregoing description. By way of example, the electronic document management system can also be used in medical applications where a digital signature is required to effect such procedures as a lab test order. Additionally, while the described embodiment uses Model-View-Controller based architecture to tie HTML front end and J2EE back end, any architecture that will accommodate user interfaces including but not limited to Java Swing, Java Applet, and MOTIF can be used. Business logic can be implemented in any of several programming languages including but not limited to C, C++, and Visual Basic. Data sources that can utilized include but are not limited to relational databases, object databases, and file-based databases. The architecture should be capable of being integrated cryptography API's dealing with X.509 certificates. Also, although in the preferred embodiment of the system, it is used to manage externally generated documents, the system is capable of managing internally generated documents. Finally, while the preferred embodiment is a real-time digital certificate generator for effecting electronic signatures, the present invention may be utilized for various types of digital identities and is not limited just to digital certificates. All such modifications and improvements have been deleted herein for the sake of conciseness and readability but are properly within the scope of the following claims.

We claim:

1. An electronic document management system, said system comprising:
(a) a document entry module;
(b) a document management module; and
(c) a real time digital certificate generator for effecting electronic signatures.

2. The apparatus according to claim 1, further including a document repository module, said document repository module including means for storing documents and means for accessing documents.

3. The apparatus according to claim 2, wherein the means for accessing documents includes means for sorting documents.

4. The apparatus according to claim 2, wherein the means for accessing documents includes means for versioning documents.

5. The apparatus according to claim 2, wherein the means for accessing documents includes means for performing validations on documents.

6. The apparatus according to claim 2, further including means for filtering documents by user-defined criteria.

7. The apparatus according to claim 3, wherein the means for filtering documents by user defined criteria includes means for defining filters.

8. The apparatus according to claim 3, wherein said means for filtering documents includes pre-selected criteria.

9. The apparatus according to claim 8, wherein said pre-selected criteria includes grouped documents.

10. The apparatus according to claim 6, wherein means for filtering documents by user defined criteria further includes means for grouping filtered documents.

11. The apparatus according to claim 2, further including a transactions module.

12. The apparatus according to claim 11, wherein said transaction module further includes means for batch transferring documents.

13. The apparatus according to claim 1, wherein said document entry module includes means for uploading documents and means for naming each document.

14. The apparatus according to claim 13, wherein the means for uploading documents includes means for specifying documents to be uploaded.

15. The apparatus according to claim 13, wherein the means for uploading documents includes means for uploading documents singly.

16. The apparatus according to claim 13, wherein the means for uploading documents includes means for uploading document packages.

17. The apparatus according to claim 16, wherein the means for uploading documents includes means for uploading documents via a business to business (B2B) integration with document source.

18. The apparatus according to claim 16, wherein the means for uploading documents includes means for uploading documents through a web browser.

19. The apparatus according to claim 16, wherein the means for uploading documents includes means for specifying the structure of the document package.

20. The apparatus according to claim 19, wherein the means for selecting the structure of the document package includes means for defining the structure of the document package.

21. The apparatus according to claim 19, wherein the means for specifying the structure of the document package includes means for cataloguing and storing structures of document packages.

22. The apparatus according to claim 21, wherein the means for cataloguing and storing structures of document packages includes means for describing a business purpose of a document.

23. The apparatus according to claim 21, wherein the means for cataloguing and storing structures of document packages includes means for parsing the contents of document packages into individual documents.

24. The apparatus according to claim 13, wherein said documents are imported electronically.

25. The apparatus according to claim 13, wherein said documents are scanned into an electronic format prior to being imported.

26. The apparatus according to claim 13, wherein said document format is selected from the group consisting of PDF, XHTML, PCL, JPEG, GIF, TIFF, PS and XML and combinations thereof.

27. The apparatus according to claim 13, wherein said documents are externally generated.

28. The apparatus according to claim 13, wherein said means for naming each document further includes means for associating related entries of documents.

29. The apparatus according to claim 28, wherein said means for associating related entries of documents includes means for associating related entries of documents in a hierarchal manner.

30. The apparatus according to claim 13, wherein said means for naming further includes means for naming each document.

31. The apparatus according to claim 13, further including means for setting privileges.

32. The apparatus according to claim 1, wherein said document management module includes means for displaying documents and means for attaching an electronic signature to a document.

33. The apparatus according to claim 32, wherein said means for attaching an electronic signature to a document includes means for attaching a system-generated tamper seal.

34. The apparatus according to claim 32, wherein said means for attaching an electronic signature to a document includes means for permitting system users to attach a click signature to a document.

35. The apparatus according to claim 32, wherein said means for attaching an electronic signature to a document includes means for permitting system users to attach a biometric signature to a document.

36. The apparatus according to claim 32, wherein said means for displaying includes a browser.

37. The apparatus according to claim 36, wherein said browser is an Internet browser.

38. The apparatus according to claim 32, wherein said means for displaying is a Personal Digital Assistant (PDA).

39. The apparatus according to claim 32, wherein said means for displaying is a kiosk.

40. The apparatus according to claim 39, wherein said kiosk is located at the closing agent.

41. The apparatus according to claim 32, wherein said means for attaching electronic signature is a digital certificate to effect a digital signature.

42. The apparatus according to claim 32, wherein said means for attaching electronic signature is a pin signature to effect signature.

43. The apparatus according to claim 32, further including an order module.

44. The apparatus according to claim 43, wherein said order module includes a list of available service providers and means of selecting one or more services from said service providers.

45. The apparatus according to claim 44, wherein said list of available service providers is a product catalog.

46. The apparatus according to claim 44, further including filtering means.

47. The apparatus according to claim 46, wherein said filtering means is a preferences filter.

48. The apparatus according to claim 46, wherein said filtering means is a locations filter.

49. The apparatus according to claim 44, further including means for associating one or more documents with a selected entry.

50. The apparatus according to claim 32, further includes means for printing documents.

51. The apparatus according to claim 32, further including means for downloading electronic copies of documents.

52. The apparatus according to claim 32, further including means for deleting selected documents.

53. The apparatus according to claim 32, further including means for displaying document histories.

54. The apparatus according to claim 32, further including means for changing document privileges.

55. A real time digital certificate generator for effecting electronic signatures for an electronic document management system, said apparatus comprising:
(a) means for entering data for certificate recipient including an entrusted identification and authentication (I&A);
(b) means for initiating the generation of a key pair for the digital certificate;
(c) means for transmitting data to a certificate authority; and
(d) means for receiving the digital certificate from the certificate authority.

56. The apparatus according to claim 55, further including means for automatically associating the digital certificate with the certificate recipient system user ID.

57. The apparatus according to claim 56, further including means for automatically removing the certificate.

58. The apparatus according to claim 57, wherein said means for automatically removing the certificate removes the certificate from means for data entry.

59. The apparatus according to claim 55, further including means for providing secondary verification.

60. The apparatus according to claim 59, wherein said means for providing secondary verification is a system user ID.

61. The apparatus according to claim 55, wherein said means for initiating the generation of a key pair for the digital certificate further includes means for generating the initiation of a key pair for a browser-based digital certificate.

62. The apparatus according to claim 55, wherein said means for initiating the generation of a key pair for the digital certificate further includes means for generating the initiation of a key pair for a roaming digital certificate.

63. The apparatus according to claim 55, wherein said means for initiating the generation of a key pair for the digital certificate further includes means for generating the initiation of a key pair for a hardware-based digital certificate.

64. The apparatus according to claim 55, wherein said means for receiving the digital certificate from the certificate authority further includes means for automatically installing the certificate on a computer's browser.

65. The apparatus according to claim 55, further including means for managing the life cycle of the certificate from within the document management system.

66. The apparatus according to claim 65, wherein said means for managing the life cycle of the certificate from within the document management system includes means for performing processes necessary to renew the digital certificate.

67. The apparatus according to claim 65, wherein said means for managing the life cycle of the certificate from within the document management system includes means for revoking the digital certificate.

68. The apparatus according to claim 65, wherein said means for managing the life cycle of the certificate from within the document management system includes means for performing processes necessary for certificate recipient customer support.

69. An electronic document management system, said system comprising:
(a) a document entry module;
(b) a document management module;
(c) a real time digital certificate generator for effecting electronic signatures, said real time digital certificate generator including:
(i) means for entering data for certificate recipient including an entrusted identification and authentication (I&A); (ii) means for generating a key pair; (iii) means for transmitting data to a certificate authority; and (iv) means for receiving the digital certificate from the certificate of authority; and
(d) a document repository module, said document repository module including means for storing documents and means for accessing documents.

70. The apparatus according to claim 69, wherein the means for accessing documents includes means for sorting documents.

71. The apparatus according to claim 69, wherein the means for accessing documents includes means for versioning documents.

72. The apparatus according to claim 69, wherein the means for accessing documents includes means for performing validations on documents.

73. The apparatus according to claim 69, further including means for filtering documents by user-defined criteria.

74. The apparatus according to claim 70, wherein the means for filtering documents by user defined criteria includes means for defining filters.

75. The apparatus according to claim 70, wherein said means for filtering documents includes pre-selected criteria.

76. The apparatus according to claim 75, wherein said pre-selected criteria includes grouped documents.

77. The apparatus according to claim 73, wherein means for filtering documents by user defined criteria further includes means for grouping filtered documents.

78. The apparatus according to claim 69, further including a transactions module.

79. The apparatus according to claim 78, wherein said transaction module further includes means for batch transferring documents.

80. The apparatus according to claim 69, wherein said document entry module includes means for uploading documents and means for naming each document.

81. The apparatus according to claim 80, wherein the means for uploading documents includes means for specifying documents to be uploaded.

82. The apparatus according to claim 80, wherein the means for uploading documents includes means for uploading documents singly.

83. The apparatus according to claim 80, wherein the means for uploading documents includes means for uploading document packages.

84. The apparatus according to claim 83, wherein the means for uploading documents includes means for uploading documents via a business to business (B2B) integration with document source.

85. The apparatus according to claim 83, wherein the means for uploading documents includes means for uploading documents through a web browser.

86. The apparatus according to claim 83, wherein the means for uploading documents includes means for specifying the structure of the document package.

87. The apparatus according to claim 86, wherein the means for selecting the structure of the document package includes means for defining the structure of the document package.

88. The apparatus according to claim 86, wherein the means for specifying the structure of the document package includes means for cataloguing and storing structures of document packages.

89. The apparatus according to claim 88, wherein the means for cataloguing and storing structures of document packages includes means for describing a business purpose of a document.

90. The apparatus according to claim 88, wherein the means for cataloguing and storing structures of document packages includes means for parsing the contents of document packages into individual documents.

91. The apparatus according to claim 80, wherein said documents are imported electronically.

92. The apparatus according to claim 80, wherein said documents are scanned into an electronic format prior to being imported.

93. The apparatus according to claim 80, wherein said document format is selected from the group consisting of PDF, XHTML, PCL, JPEG, GIF, TIFF, PS and XML and combinations thereof.

94. The apparatus according to claim 80, wherein said documents are externally generated.

95. The apparatus according to claim 80, wherein said means for naming each document further includes means for associating related entries of documents.

96. The apparatus according to claim 95, wherein said means for associating related entries of documents includes means for associating related entries of documents in a hierarchal manner.

97. The apparatus according to claim 80, wherein said means for naming further includes means for naming each document.

98. The apparatus according to claim 80, further including means for setting privileges.

99. The apparatus according to claim 69, wherein said document management module includes means for displaying documents and means for attaching an electronic signature to a document.

100. The apparatus according to claim 99, wherein said means for attaching an electronic signature to a document includes means for attaching a system-generated tamper seal.

101. The apparatus according to claim 99, wherein said means for attaching an electronic signature to a document includes means for permitting system users to attach a click signature to a document.

102. The apparatus according to claim 99, wherein said means for attaching an electronic signature to a document includes means for permitting system users to attach a biometric signature to a document.

103. The apparatus according to claim 99, wherein said means for displaying includes a browser.

104. The apparatus according to claim 103, wherein said browser is an Internet browser.

105. The apparatus according to claim 99, wherein said means for displaying is a Personal Digital Assistant (PDA).

106. The apparatus according to claim 99, wherein said means for displaying is a kiosk.

107. The apparatus according to claim 106, wherein said kiosk is located at the closing agent.

108. The apparatus according to claim 99, wherein said means for attaching electronic signature is a digital certificate to effect a digital signature.

109. The apparatus according to claim 99, wherein said means for attaching electronic signature is a pin signature to effect signature.

110. The apparatus according to claim 99, further including an order module.

111. The apparatus according to claim 110, wherein said order module includes a list of available service providers and means of selecting one or more services from said service providers.

112. The apparatus according to claim 111, wherein said list of available service providers is a product catalog.

113. The apparatus according to claim 111, further including filtering means.

114. The apparatus according to claim 113, wherein said filtering means is a preferences filter.

115. The apparatus according to claim 113, wherein said filtering means is a locations filter.

116. The apparatus according to claim 111, further including means for associating one or more documents with a selected entry.

117. The apparatus according to claim 99, further includes means for printing documents.

118. The apparatus according to claim 99, further including means for downloading electronic copies of documents.

119. The apparatus according to claim 99, further including means for deleting selected documents.

120. The apparatus according to claim 99, further including means for displaying document histories.

121. The apparatus according to claim 99, further including means for changing document privileges.

122. The apparatus according to claim 69, further including means for automatically associating the digital certificate with the certificate recipient system user ID.

123. The apparatus according to claim 122, further including means for automatically removing the certificate.

124. The apparatus according to claim 123, wherein said means for automatically removing the certificate removes the certificate from means for data entry.

125. The apparatus according to claim 69, further including means for providing secondary verification.

126. The apparatus according to claim 125, wherein said means for providing secondary verification is a system user ID.

127. The apparatus according to claim 69, wherein said means for initiating the generation of a key pair for the digital certificate further includes means for generating the initiation of a key pair for a browser-based digital certificate.

128. The apparatus according to claim 69, wherein said means for initiating the generation of a key pair for the digital certificate further includes means for generating the initiation of a key pair for a roaming digital certificate.

129. The apparatus according to claim 69, wherein said means for initiating the generation of a key pair for the digital certificate further includes means for generating the initiation of a key pair for a hardware-based digital certificate.

130. The apparatus according to claim 69, wherein said means for receiving the digital certificate from the certificate authority further includes means for automatically installing the certificate on a computer's browser.

131. The apparatus according to claim 69, further including means for managing the life cycle of the certificate from within the document management system.

132. The apparatus according to claim 131, wherein said means for managing the life cycle of the certificate from within the document management system includes means for performing processes necessary to renew the digital certificate.

133. The apparatus according to claim 131, wherein said means for managing the life cycle of the certificate from within the document management system includes means for revoking the digital certificate.

134. The apparatus according to claim 131, wherein said means for managing the life cycle of the certificate from within the document management system includes means for performing processes necessary for certificate recipient customer support.

135. A method for generating a real time digital certificate for effecting electronic signatures for an electronic document management system, said method comprising the steps of:
(a) entering data for certificate recipient including an entrusted identification and authentication (I&A);
(b) initiating the generation of a key pair for the digital certificate;
(c) transmitting data to a certificate authority; and
(d) receiving the digital certificate from the certificate authority.
